(19) United States
(12) Patent Application Publication
(10) Pub. No.: US 2012/0092263 A1
(43) Pub. Date: Apr. 19, 2012

(54) HAPTIC KEYBOARD FEATURING A SATISFYING TACTILE KEYPRESS EXPERIENCE

(75) Inventors: Cody George Peterson, Coeur d'Alene, ID (US); Douglas M. Krumpelman, Hayden, ID (US); Andrew Parris Huska, Post Falls, ID (US)

(73) Assignee: PACINIAN CORPORATION, Spokane, WA (US)

(21) Appl. No.: 13/334,410

(22) Filed: Dec. 22, 2011

Related U.S. Application Data
(63) Continuation-in-part of application No. 12/580,002, filed on Oct. 15, 2009.
(60) Provisional application No. 61/429,749, filed on Jan. 4, 2011.

(51) Int. Cl. G06F 3/02

(52) U.S. Cl. 345/168

(57) ABSTRACT

Described herein are techniques related to a haptic keyboard that features a satisfying tactile keypress experience. Using active tactile feedback (i.e., haptics) via its keys, one or more of the described example keyboards simulates the feel of a snap-over keypress of conventional keys, such as that of a rubber-dome keyboard. With its haptics, one or more of the described example keyboards feel like—through the user's fingers on keycaps—keys having the non-linear force/displacement characteristics of the snap-over of conventional keys. This Abstract is submitted with the understanding that it will not be used to interpret or limit the scope or meaning of the claims.

### RELATED APPLICATION

This non-provisional patent application is related to, claims the benefit of priority to, and is a continuation-in-part of U.S. Non-Provisional patent application Ser. No. 12/580,002, filed on Oct. 15, 2009. This non-provisional patent application is related to and claims the benefit of priority to U.S. Provisional Patent Application No. 61/429,749, filed on Jan. 4, 2011. The disclosures of each above-listed patent applications is incorporated by reference herein.

### BACKGROUND

The various flavors of conventional computer keyboards are typically classified based upon various factors, which include 1) the type of keyswitches used, 2) the key responses, and 3) the key travel. The keyswitches determine whether the key is fully pressed, the key response is the passive feedback of a key that has been pressed, and the key travel is the distance needed to push the key to enter a character reliably (i.e., to activate the above-mentioned keyswitch).

Common examples of conventional keyboard flavors include the following: rubber-dome; scissor-switch; capacitive; mechanical-switch; buckling-spring; Hall-effect; laser; membrane; and roll-away. Of course, some conventional keyboards combine flavors. For example, rubber-dome keyboards are a ubiquitous keyboard technology that is effectively a hybrid of membrane and mechanical-switch keyboards (and sometimes scissor-switch as well).

FIGS. 1-4 illustrate a series of snapshots of an example of a conventional rubber-dome type of key 100 as it is being pressed by a user's finger 120. FIG. 5 has a force-travel (i.e., force-displacement) diagram 500 of a keypress of a conventional rubber-dome key, like the key 100 shown in FIGS. 1-4. In this diagram 500, the y-direction is the force “f” with which a user presses the key and the x-direction is the travel “t” of the key (i.e., “key travel”). Down-keypress curve 510 of diagram 500 shows the force-travel of the user pressing the key down. Up-keypress curve 520 of diagram 500 shows the force-travel of the user lifting his finger after a depressing the keys.

FIG. 1 shows a cross-section of the example conventional rubber-dome key 100 in an unpressed or neutral state. This neutral state is labeled “A” in FIG. 1 and corresponds to label “A” on down-keypress curve 510 of force-travel diagram 500 of FIG. 5. The key 100 is topped with a keycap 102, which is where a person touches and presses the key. The “dome” body of this example conventional rubber-dome key 100 is formed, at least in part, by an elastomeric wall, which is shown in the cross-section as walls 104 and 106 in FIG. 1. This dome shape is sometimes called a bubble or plunger. The key 100 also includes an upper keyswitch contact 108 and a lower keyswitch contact 110. In the key's neutral state (as shown in FIG. 1), the contacts are separated from each other.

The conventional rubber-dome key 100 depicted and described herein is merely one example of the many similar conventional key assemblies. For example, the following U.S. patents describe and illustrate other conventional rubber-dome key technologies: U.S. Pat. Nos. 6,534,736; 6,288,353; 5,990,435; and 5,212,356.

FIG. 2 shows the example conventional rubber-dome key 100 as the user presses the key down. When the key 100 is pressed, the rubber dome under the pressed key resists initially and then eventually collapses under continued pressure from the user's finger. This initial resistance is shown as a sharp increase in force “f” over key-travel “t” between “A” and “B” of the down-keypress curve 510 of diagram 500.

In FIG. 2, the user pressing the key is depicted with a force arrow 122 shown on the finger 120. The elastomeric walls 104, 106 of the rubber dome are shown beginning their collapse in FIG. 2. This initial “collapsing” state is labeled “B” in FIG. 2 and corresponds to label “B” on down-keypress curve 510 of force-travel diagram 500 of FIG. 5. As shown, the user has not pressed the key far enough for the upper keyswitch contact 108 to touch the lower keyswitch contact 110.

FIG. 3 shows the example conventional rubber-dome key 100 as the user has pressed the key down sufficiently to fully collapse the dome (as shown by walls 104, 106). The dome's collapse is shown is shown as a sharp decrease in force “f” over key-travel “t” between “B” and “C” of the down-keypress curve 510 of diagram 500.

In FIG. 3, the user is shown completing the dome's collapse by continuing the press the key down. The elastomeric walls 104, 106 of the rubber dome are shown fully collapsed in FIG. 3. This fully collapsed state is labeled “C” in FIG. 3 and corresponds to label “C” on down-keypress curve 510 of force-travel diagram 500 of FIG. 5.

FIG. 3 also shows the user continuing to press the key after the dome's collapse. This is depicted with a force arrow 124 shown on the finger 120. This action is shown as a sharp increase in force “f” over key-travel “t” between “C” and “D” of the down-keypress curve 510 of diagram 500.

By continuing to press the key, the user pushes the upper and lower keyswitch contacts 108, 110 together to make a good electrical contact between each other and complete the keyswitch. This sends a signal that enters the keypress character (e.g., sends an appropriate scancode) to the host computer.

FIG. 4 shows the example conventional rubber-dome key 100 as the user lifts his finger 120. This is depicted with a force arrow 126 shown on the finger 120. The dome's reformation is shown is shown as a sharp increase in force “f” over key-travel “t” between “E” and “F” of the up-keypress curve 520 of diagram 500.

In FIG. 4, the user is shown allowing the dome's reformation by lifting his finger from the key. The elastomeric walls 104, 106 of the rubber dome are shown reforming in FIG. 4. This reformation state is labeled “E” and “F” in FIG. 4 and corresponds to labels “E” and “F” on the up-keypress curve 520 of force-travel diagram 500 of FIG. 5.

FIG. 1 also shows the key after the user has lifted his finger up off the key 100. Thus, the key 100 is once again in its neutral or unpressed state (“A”) and it is ready to be pressed once again.

Like the buckling-spring technology before it, the rubber-dome technology provides a satisfying tactile keypress experience. That experience includes a key response that provides non-linear force-travel characteristics. An example of non-linear force-travel characteristics of the key response of a satisfying tactile keypress experience is shown by curves 510 and 520 of force-travel diagram 500 of FIG. 5.

For conventional technology, the satisfying key response requires the user to apply a displacement force that initially increases with displacement (i.e., key travel) to a predetermined displacement distance (i.e., the breakover point), which is labeled “B” on the down-keypress curve 510 of diagram 500 of FIG. 5. After the breakover point, the displacement force needs to press the key to significantly decrease with key-travel distance until bottoming point, which is labeled “C” on the down-keypress curve 510.

In other words, the key response of the satisfying tactile keypress experience includes an initial resistance by the key to the force applied by the user's finger. Thus, when only applying a slight pressure or force on the key (like when the user rests his finger on the key), the user does not inadvertently select the key. In order for a user to purposefully select the key, he must apply a sufficient force to reach the key's so-called breakover point. At that point of key travel, the dome collapses (or the spring buckles) and the key bottoms out. This action typically completes the key switch. In addition, this action provides a tactile sensation as the key bottoms out and there is additional resistance as the electrical keyswitch contacts are made. This key response is often called “snap-over” and it is part of the satisfying tactile keypress experience. The down-keypress curve 510 of diagram 500 maps the force-travel of the snap-over key response.

Moreover, the key response also includes the tactile sensation of a key-return snap, which the user may feel after lifting his finger from the bottomed-out key. Under the biased force of the rubber dome, buckled spring, or the like, the depressed key snaps back to its original unpressed position after the user lifts his finger from the key. Indeed, the key may actually hit the user's finger when it snaps back. The up-keypress curve 520 of diagram 500 maps the force-travel of this “snap-back” key response when the key returns to its neutral state (“A”). The highlight of the snap-back is shown at points E and F on the curve 520.

Conventionally, key response of this satisfying tactile keypress experience depends upon having a sufficient key-travel distance to provide the described non-linear force/displacement characteristics (as charted by diagram 500). Unfortunately, as electronic and computing devices with keyboards (e.g., laptops) have gotten slimmer and thinner, key-travel distance has necessarily decreased. Consequently, the key response of this satisfying tactile keypress experience has significantly decreased or disappeared entirely in contemporary slimmer and thinner devices.

As noted by the Wall Street Journal (“A Passion for Keys” by Jeremy Wagstaff, Nov. 23, 2007), “[Us] users care deeply about our keyboard. To be more specific, our keys” and to keyboard users “it's the touch, response, action . . . of the keys themselves that really matters.” Despite the fervent clamor of keyboard users, the satisfying tactile keypress experience has been sacrificed at the altar of advancing technology that packs more functionality into slimmer and thinner envelopes.

Accordingly, no existing solution exists that can offer a thin keyboard that is as slim as or slimmer than conventional keyboards without sacrificing the above-described satisfying tactile keypress experience.

### SUMMARY

Described herein are techniques related to a haptic keyboard that feature a satisfying tactile keypress experience. Using active tactile feedback (i.e., haptics) via its keys, one or more of the described example keyboards simulates the feel of a snap-over keypress of conventional keys, such as that of a rubber-dome keyboard. With its haptics, one or more of the described example keyboards feel like—through the user's fingers on keycaps—keys having the non-linear force/displacement characteristics of the snap-over of conventional keys.

This Summary is submitted with the understanding that it will not be used to interpret or limit the scope or meaning of the claims. This Summary is not intended to identify key features or essential features of the claimed subject matter, nor is it intended to be used as an aid in determining the scope of the claimed subject matter.

### BRIEF DESCRIPTION OF THE DRAWINGS

FIGS. 1-4 are cross-sectional side elevation views of a conventional rubber-dome key. FIG. 1 shows the key in its neutral or unpressed state. FIG. 2 shows the key being pressed by a user's finger. FIG. 3 shows the key fully pressed by a finger. FIG. 4 shows the key returning to its original position as the user lifts his finger.

FIG. 5 is a force-travel diagram showing a representation of the key response and key travel characteristics of a conventional rubber-domed key.

FIGS. 6-8 are three different views of an example haptic keyboard that is configured to implement the techniques described herein to provide a satisfying tactile user experience. FIG. 6 is an isometric view of the example haptic keyboard. FIG. 7 is top plan view of the example haptic keyboard. FIG. 8 is a side elevation view of the example haptic keyboard.

FIG. 9 is an exploded view of an example haptic keyboard that is configured to implement the techniques described herein to provide a satisfying tactile user experience.

FIG. 10 is a cross-sectional side elevation view of a cutaway of an example haptic keyboard that is configured to implement the techniques described herein to provide a satisfying tactile user experience.

FIGS. 11-20 are a cross-sectional side elevation view of a cut-away of an example haptic keyboard that is configured to implement the techniques described herein to provide a satisfying tactile user experience. Each of FIGS. 11-20 also include the force-travel diagram of FIG. 5 of a conventional key. Each successive figure shows successive snapshots of a keypress on the example haptic keyboard. The diagram of each figure has a star mapped onto a keypress curve to indicate where keypress on the example haptic keyboard maps onto the keypress curve of a conventional key.

FIG. 21 is a cross-sectional side elevation view of a cut-away of an example backlit haptic keyboard that is configured to implement the techniques described herein to provide a satisfying tactile user experience.

FIG. 22 is a block diagram of components of an example haptic keyboard that is configured to implement the techniques described herein to provide a satisfying tactile user experience.

FIGS. 23 and 24 are flow diagrams of one or more example processes, each of which implements the techniques described herein.

FIG. 25 illustrates a high-level block diagram of an example system in accordance with one or more embodiments.

The Detailed Description references the accompanying figures. In the figures, the left-most digit(s) of a reference number identifies the figure in which the reference number first appears. The same numbers are used throughout the drawings to reference like features and components.

### DETAILED DESCRIPTION

Described herein are techniques related to a haptic keyboard that features a satisfying tactile keypress experience. Using active tactile feedback (i.e., haptics) via its keys, one or more of the described example keyboards simulates the feel of a snap-over keypress of conventional keys, such as that of a rubber-dome keyboard. With its haptics, one or more of the described example keyboards feel like—through the user's fingers on keycaps—keys having the non-linear force/displacement characteristics of the snap-over of conventional keys. An example of such characteristics is charted by curves 510 and 520 of force-travel diagram 500.

Herein, an example of an embodiment of a “Haptic Keyboard Featuring a Satisfying Tactile Keypress Experience” may be referred to as an “exemplary haptic keyboard.” While one or more example embodiments are described herein, the reader should understand that the claimed invention may be practiced using different details than the exemplary ones described herein.

The example haptic keyboards described herein may be constructed exceptionally thin while providing the satisfying tactile keypress experience (i.e., snap-over simulation). In addition, the example haptic keyboard includes a common haptic actuator for multiple keys of the keyboard. In addition, unlike most keyboards, the keyboard mechanics and electronics of the example haptic keyboard is contained within a watertight seal.

The following U.S. patent applications are incorporated by reference herein:
U.S. patent application Ser. No. 12/580,002, filed on Oct. 15, 2009;
U.S. Provisional Patent Application Ser. No. 61/347,768, filed on May 24, 2010;
U.S. Provisional Patent Application Ser. No. 61/410,891, filed on Nov. 6, 2010; and
U.S. patent application Ser. No. 12/975,733, filed on Dec. 22, 2010.

### Example Haptic Keyboard

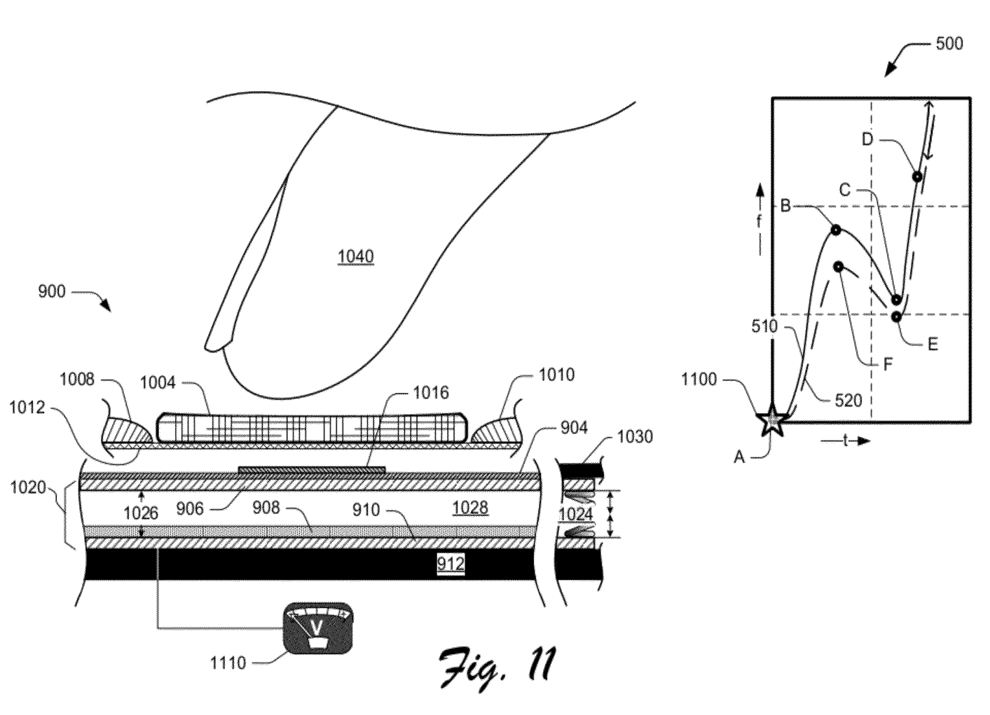

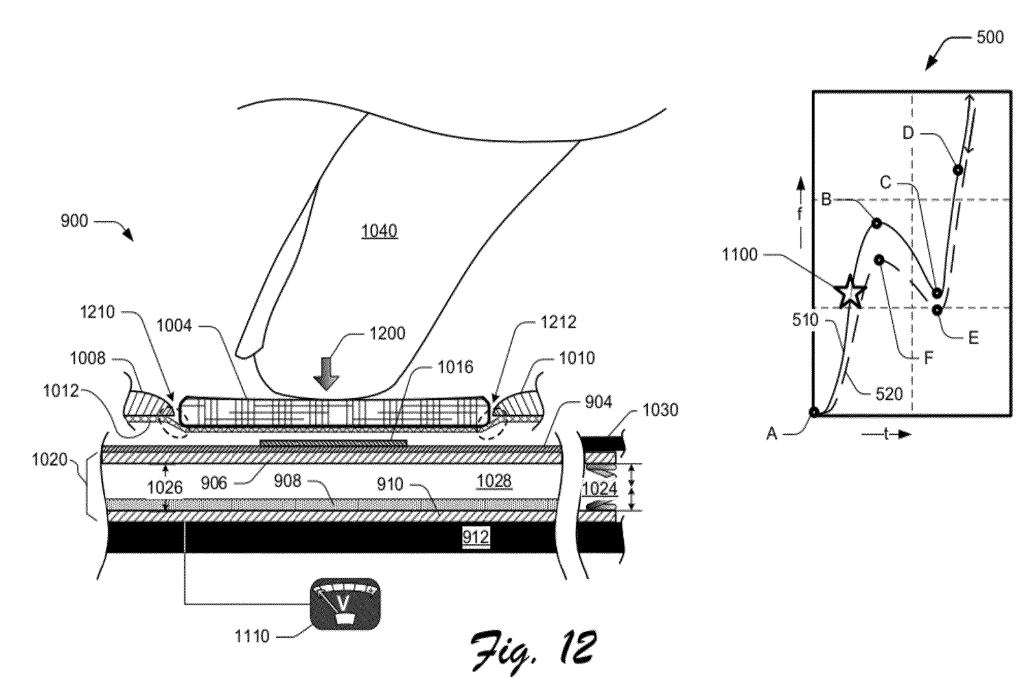

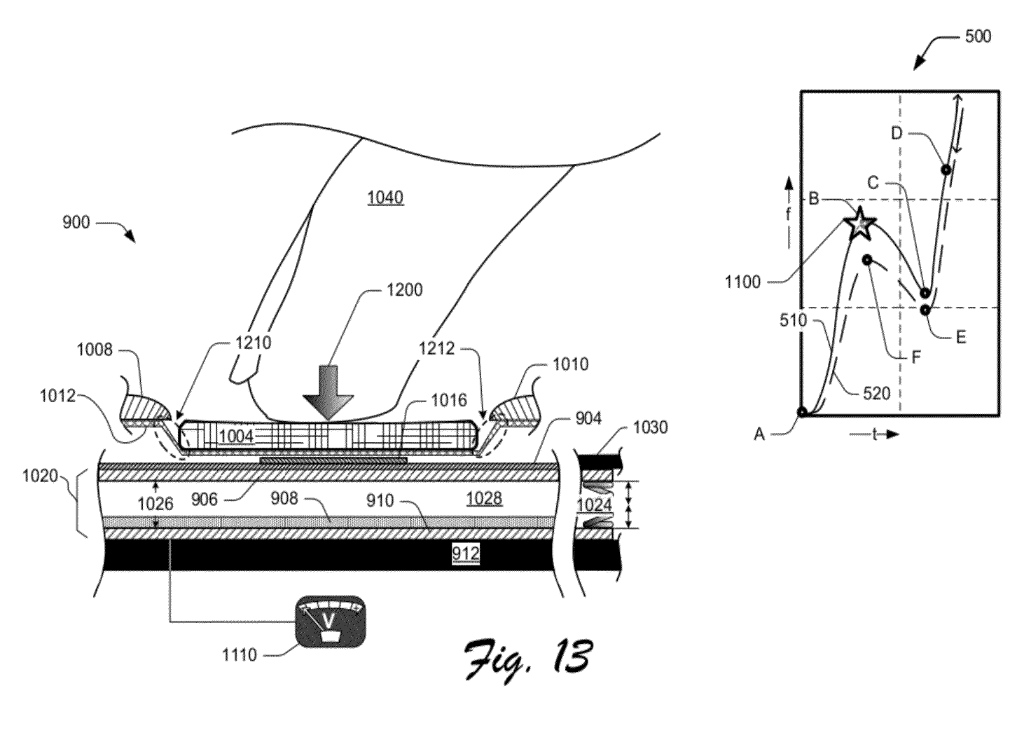

FIGS. 6-8 offer three different views of an example haptic keyboard 600 that is configured to implement the techniques described herein to provide a satisfying tactile user experience. FIG. 6 is an isometric view of the example haptic keyboard 600. FIG. 7 is top pan view of the example haptic keyboard 600. FIG. 8 is a side elevation view of the example haptic keyboard 600. As depicted, the example haptic keyboard 600 has a housing 602, an array of keys 604, and a touchpad 606.

As can be seen by viewing the example haptic keyboard 600 from the three points of view offered by FIGS. 6-8, the example haptic keyboard is exceptionally thin (i.e., low-profile) in contrast with a keyboard having conventional snap-over keys, like rubber-dome keys. A conventional keyboard is typically 12-30 mm thick (measured from the bottom of the keyboard housing to the top of the keycaps). Examples of such keyboards can be seen the drawings of U.S. Pat. Nos. D278,239, D292,801, D284,574, D527,004, and D312,623. Unlike these traditional keyboards, the example haptic keyboard 600 has a thickness 608 that is less than 4 mm thick (measured from the bottom of the keyboard housing to the top of the keycaps). With other implementations, the keyboard may be less than 3 mm or even 2 mm.

This example haptic keyboard 600 is a stand-alone keyboard rather than one integrated with a computer, like the keyboards of a laptop computer. Of course, alternative implementations may have a keyboard integrated within the housing or chassis of the computer or other device components. The following are examples of devices and systems that may use or include a keyboard like the example haptic keyboard (by way of example only and not limitation): a mobile phone, electronic book, computer, laptop, tablet computer, stand-alone keyboard, input device, monitor, electronic kiosk, gaming device, automated teller machine (ATM), vehicle dashboard, control panel, medical workstation, and industrial workstation.

As described herein, the example haptic keyboard 600 includes an electro-mechanical movement-effecting mechanism designed to move an electronically conductive plane using electrostatic forces. This movement is designed to simulate the feel of the snap-over of a conventional key. Typically, the electronically conductive plane is moved in one or more directions that are towards and/or away from the key.

FIG. 9 shows an exploded view of an example assembly 900 of the example haptic keyboard 600. The keyboard housing 602 includes top bezel 902 and base 912. On the top bezel 902 are keys 604, which are actually a plurality of keycaps. Each keycap is in one of a plurality of keyframes. Each of the keyframes defines an opening in a top of the housing (i.e., top bezel 902), but each of those openings is closed by a flexible platform (the sealing platform which is not seen in FIG. 9), which is attached to the underside of the top bezel 902. Each keycap is in a keyframe and on the flexible platform.

Between the top bezel 902 and the base 912, the keyboard 600 includes a sensor membrane circuit 904, an upper actuator plane 906, a dielectric layer 908, and lower actuator plane 910.

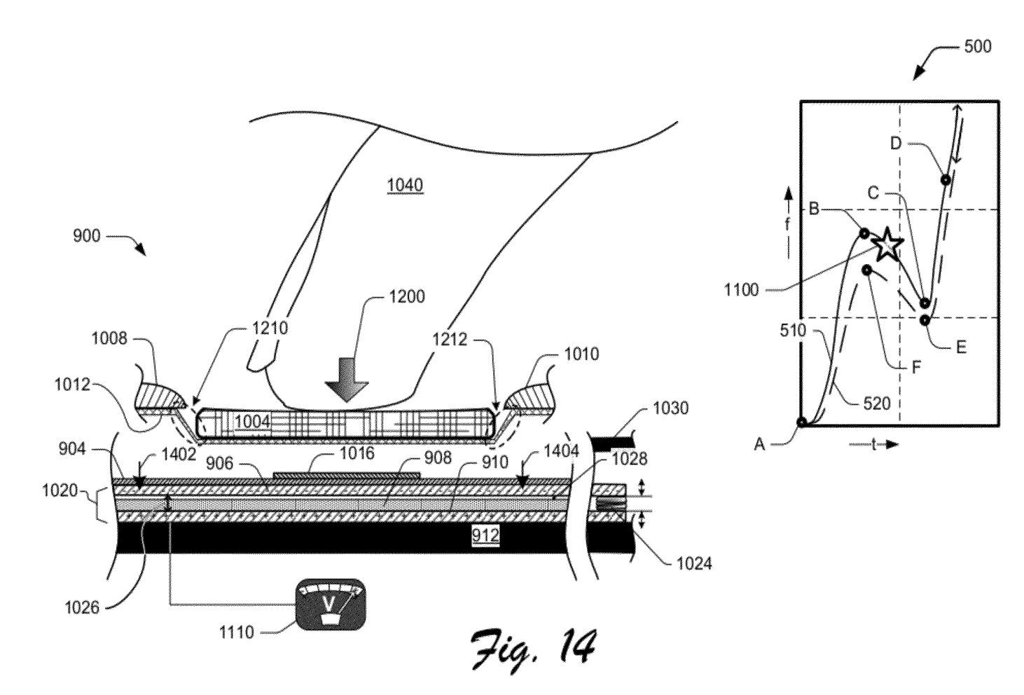

FIG. 10 is a cross-section of a cutaway of the example assembly 900 of the example haptic keyboard. The example assembly 900 includes multiple keycaps, such as keycaps 1002 and 1004. For context, a fingertip 1040 of a user is shown hovering over the keycap 1004. The keycaps are with (e.g., held within the bounds of) a keyframe (such as keyframes 1006, 1008, 1010) of the top bezel 902. The keycaps 1002, 1004 are positioned with (e.g., on top of) an elastomeric sealing platform 1012 (which may be called a flexible platform, sealing membrane, or the like). The keycaps may just rest on top of the platform or be attached to the platform or some other component of the keyboard.

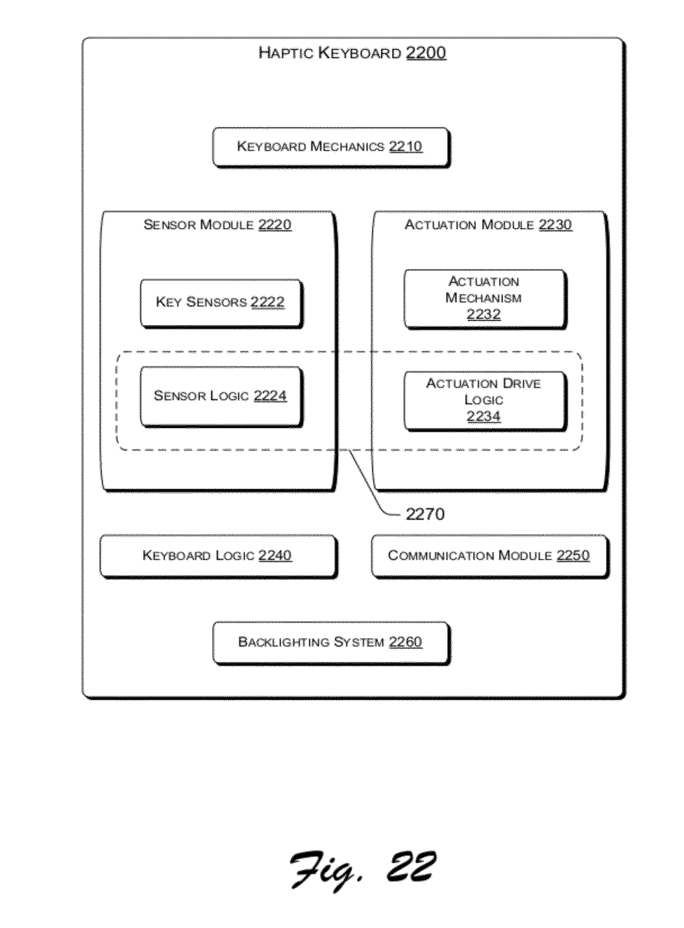

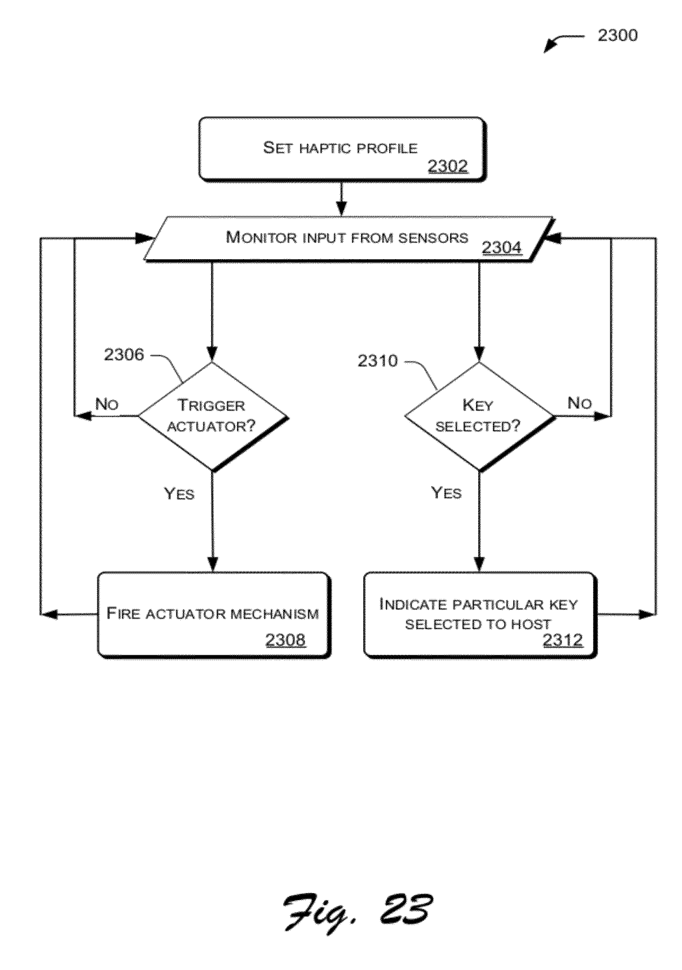

As shown in FIG. 10, the sensor membrane 904 is below the keycaps 1002, 1004 and the top bezel (as represented in FIG. 10 as keyframes 1006, 1008, 1010). The sensor membrane 904 connects an array of force-sensing key sensors (such as sensors 1014, 1016) to a sensor logic (such as sensor logic 2224, which is described in relationship to FIG. 22). Each of the key sensors is positioned under and corresponds to a particular keycap.

Sensor 1014 is positioned directly under keycap 1002 and corresponds to that keycap. Similarly, sensor 1016 is positioned directly under keycap 1004 and corresponds to that keycap. Each sensor sends force-sensing signals to the sensor logic in response to the force applied by its corresponding keycap when pressed by a user.

The example assembly 900 also includes an actuation mechanism 1020, which includes the upper actuation plane 906, a return mechanism, the dielectric layer 908, and the lower actuation plane 910. The return mechanism is represented herein by springs 1022 and 1024. A return-stop ridge 1030 is firmly attached to the housing/chassis of the keyboard and it stops the upward movement of the upper actuation plane 906. That upward movement is typically caused by the return mechanism (e.g., springs 1022, 1024) urging the upper actuation plane back to its original position after actuation is released.

The return mechanism is operably associated with (e.g., connected or coupled to) at least one of the pair of actuation planes. The return mechanism is designed to return the pair of planes, after a movement of the planes relative to each other, back to the spaced-apart position relative to each other and restore the defined gap therebetween. That is, the return mechanism restores the defined gap between the actuation planes.

As depicted herein, the upper actuation plate 906 is an electrically conductive plate of sheet metal. The lower actuation plate 910 is an electrically conductive film adhered to the base 912.

While depicted in FIG. 10 and in other drawings as springs, the return mechanism may be and may include a variety of functional components. The return mechanism is described in additional detail in U.S. patent application Ser. No. 12/975,733, which is incorporated herein by reference.

As shown in FIG. 10, there is a defined gap 1026 between the two actuation planes (906, 910). Inside that defined gap is the dielectric layer 908 and an air space (i.e., air gap) 1028. The actuation mechanism 1020 rests on (and/or is attached to) the base 912 of the keyboard housing and/or chassis. While not shown in FIG. 10, the example assembly 900 also includes an actuation drive logic 2234 to control and drive the haptic actuation of the actuation mechanism 1020. The actuation drive logic 2234 is discussed later in relationship to FIG. 22.

The actuation mechanism 1020 is configured to provide tactile feedback to a user responsive to a user pressing a key (as represented by a keycap). As shown here with example assembly 900, the actuation mechanism 1020 includes at least two spaced-apart planes (e.g., upper actuation plane 906 and lower actuation plane 910). The actuation mechanism holds this pair of planes in a spaced-apart position relative to each other and with the defined gap 1026 therebetween. In this example assembly 900, the defined gap 1026 defines the distance that the planes 906, 910 are spaced apart. Typically, the defined gap 1026 is substantially smaller than the width of the expanse of the planes. In some implementations, the defined gap 1026 is 1 micron to 1 centimeter. In other implementations, the defined gap 211 is 0.2 to 2 millimeters.

The actuation mechanism 1020 is designed to permit at least one of the actuation planes to move relative to the other. This movement is effective to provide tactile feedback to the user when the user presses one of the plurality of keycaps via that keycap.

Each of the planes 906, 910 has conductive properties. Each plane may be inherently conductive or have, support, include, or otherwise integrate a layer of conductive material.

As can be seen in FIG. 10, the example haptic keyboard 600 has a common actuation mechanism (such as mechanism 1020) for multiple keys (as represented by keycaps 1002 and 1004). This arrangement works because the haptic actuation occurs much more quickly than even the fastest typist types. Under normal typing circumstances, the user only presses one key (e.g., the “A” key or the “V” key) at a time. The user feels the actuation only through the finger of the key that is pressed down and in physical contact with the actuation mechanism.

A typist typically types at approximately 30 words per minute (wpm), which means that each keypress typically takes 100 milliseconds to complete. A typical actuation of the example haptic keyboard 600 occurs in less than one millisecond in most implementations and more specifically about 250 to 750 microseconds in some implementations.

The Satisfying Tactile User Experience with the Example Haptic Keyboard

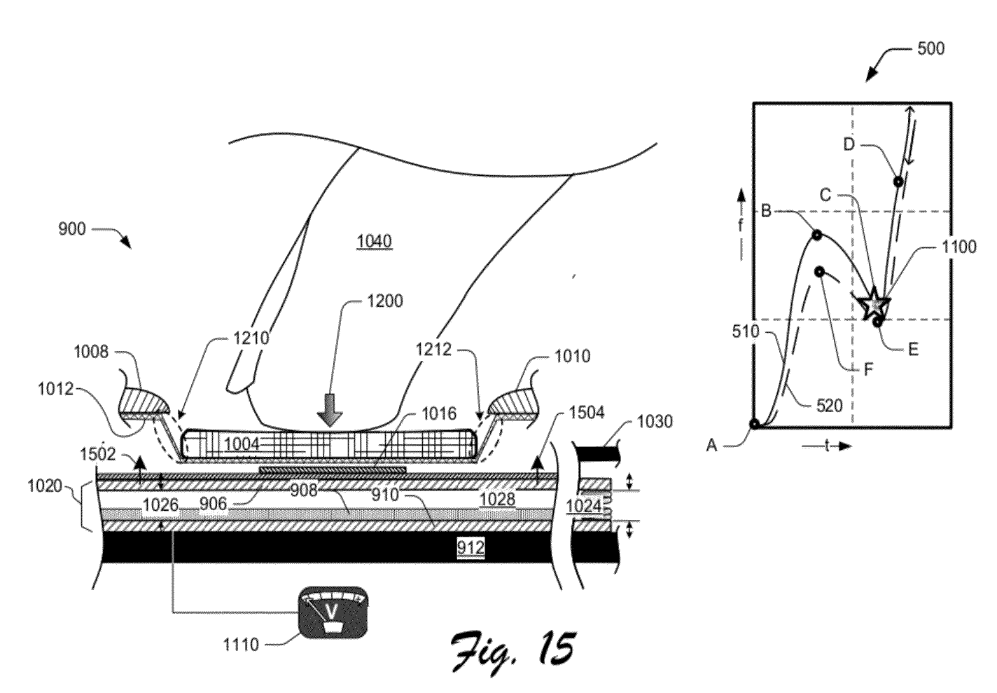

Each of FIGS. 11-20 show selected portions of the cross-sectional side elevation view of the example assembly 900 of the haptic keyboard shown in FIG. 10 and described above. Each figure shows a snapshot of the user pressing a key of example haptic keyboard 600. Taken together and in sequence, these snapshots illustrate an example electro-mechanical operation of the example haptic keyboard 600 when a user presses a key.

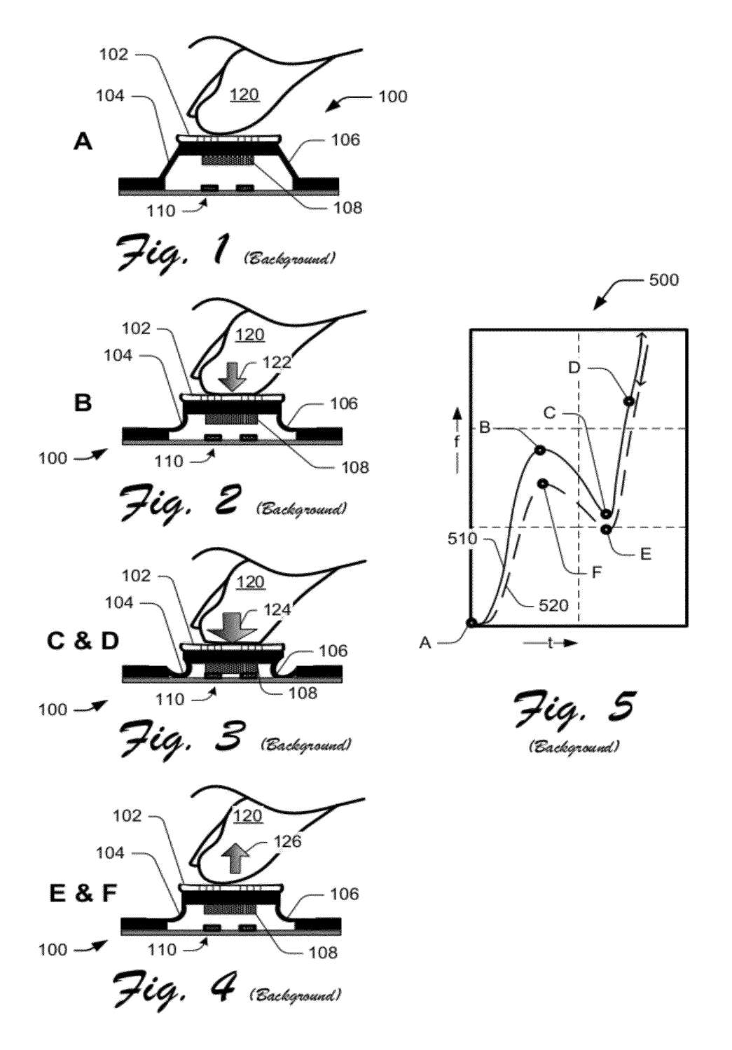

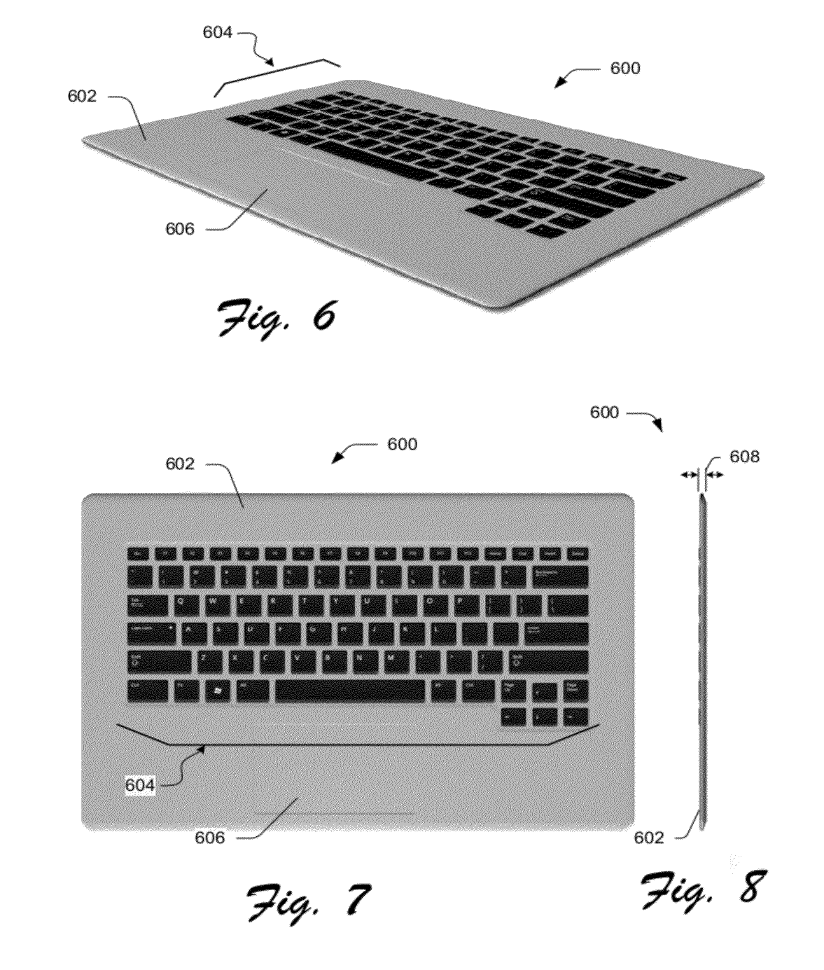

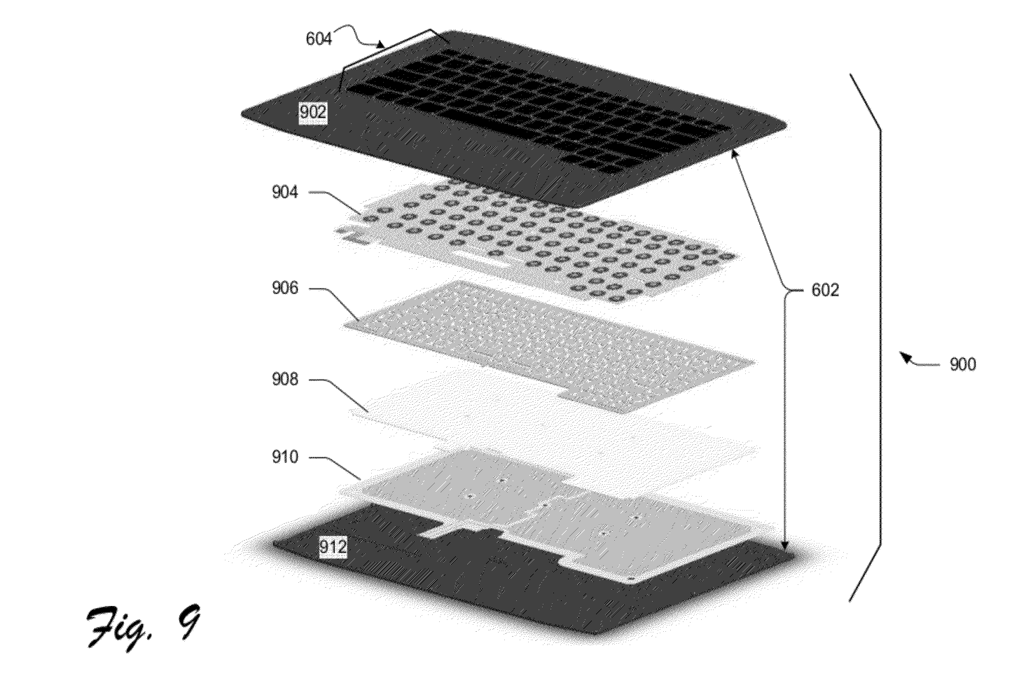

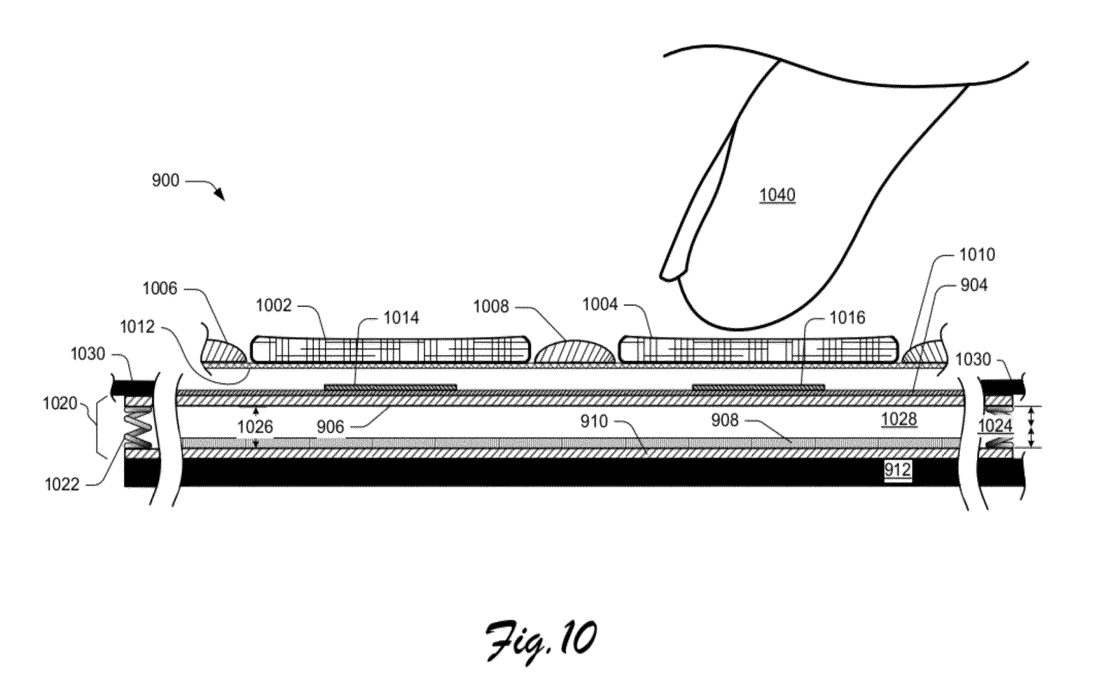

In addition, each of the FIGS. 11-20 includes the force-travel diagram 500 of FIG. 5 of a conventional key. This diagram is not representative of the force-travel characteristics of the keys of the example haptic keyboard 600. Rather, the force-travel diagram 500 in each of these figures is representative of the force-travel characteristics of the keypress of a key of a conventional keyboard, like those shown in FIGS. 1-4 and described in the background.

The purpose of showing the force-travel diagram 500 of a key of a conventional keyboard along side illustrations of a keypress of the example haptic keyboard 600 is to show how the electro-mechanical operation of the example haptic keyboard effectively simulates the snap-over of the key of a conventional keyboard. This simulation is illustrated in each figure by showing a “snapshot” star 1100 on force-travel diagram 500 of each figure. The snapshot star 1100 of each figure indicates where the snapshot of the electro-mechanical operation of the example haptic keyboard maps onto the keypress curve of the force-travel diagram 500 of a conventional key.

In addition, each of the FIGS. 11-20 include a voltmeter 1110 attached to the actuation mechanism 1020. The voltmeter 1110 is shown purely as an illustrative device. Neither the example haptic keyboard 600 nor any other alternative implementation necessarily includes a voltmeter. The voltmeter's sole purpose is to illustrate when the actuation mechanism 1020 is powered. More particularly with the example haptic keyboard 600, the voltmeter shows when the lower actuation plane 910 of the actuation mechanism is “hot” (i.e., electrical power is applied) and when it is not during the keypress sequence. When the needle of the voltmeter 1110 is pegged to the far left of the voltmeter, the lower actuation plane 910 is not hot. Conversely, when the needle of the voltmeter 1110 is pegged to the far right of the voltmeter, the lower actuation plane 910 is hot. Of course, the example haptic keyboard may utilize a range of electrical power rather than merely “on” or “off.” Nevertheless, for illustration purposes only, the power is shown only as either “on” or “off.”

FIG. 11 illustrates a neutral or unpressed state of a key of the example assembly 900 of the example haptic keyboard. The finger 1040 is hovering over the keycap 1004 in anticipation of pressing that keycap. The snapshot star 1100 is positioned in the left-hand and lower corner of the conventional-key force-travel diagram 500. Indeed, the snapshot star 1100 of this figure is positioned over point A on the down-keypress curve 510. The voltmeter 1110 of FIG. 11 shows that the actuation mechanism 1020 is unpowered in this state. FIG. 11 also illustrates the conditions after the keypress sequence of the example haptic keyboard is completed.

FIG. 12 shows the example assembly 900 during an initial state of the user pressing the key of the example haptic keyboard. The force of the finger 1040 pressing the keycap 1004 is represented by a finger vector 1200. The arrow of the finger vector 1200 indicates the direction the finger is moving and the relative size of the finger vector 1200 indicates the relative amount of force that the finger is applying to the keycap.

The stretching sections 1210, 1212 of the sealing platform 1012 are indicated inside dashed ovals. As represented by the stretching sections, the elastomeric sealing platform 1012 expands as the keycap 1004 is pressed down by the user's finger 1040. Except for the stretching sections 1210, 1212 and the keycap 1004, no other part of the example assembly 900 moves or reacts at this stage of the keypress illustrated in FIG. 12. Similarly, the voltmeter 1110 of FIG. 12 shows that the actuation mechanism 1020 is unpowered at this stage.

The snapshot star 1100 of FIG. 12 is positioned between point A and point B of the down-keypress curve 510 of the conventional-key force-travel diagram 500. The stretching of the sealing platform 1012 provides the feel of resistance that simulates the feel of a snap-over between points A and B of the down-keypress curve 510 of the force-travel diagram 500.

FIG. 13 shows the example assembly 900 in the next stage of the keypress of the example haptic keyboard. As compared to the initial stage of FIG. 12, the keycap 1004 is lower. As indicated by the relatively larger size of the finger vector 1200 in this figure in comparison to the previous figure, the user is pressing the key a bit harder. Similarly, the stretching sections 1210, 1212 of the sealing platform 1012 show that the sealing platform is stretched a bit farther than it was stretched in the previous figure. The snapshot star 1100 of FIG. 13 is positioned just before point B (i.e., the breakover point of the snap-over) of the down-keypress curve 510 of the conventional-key force-travel diagram 500.

Except for the stretching sections 1210, 1212 and the keycap 1004, no other part of the example assembly 900 has yet moved or reacted at the stage of the keypress illustrated in FIG. 13. Similarly, the voltmeter 1110 of FIG. 13 shows that the actuation mechanism 1020 is unpowered at this stage.

As shown here in FIG. 13, the sensor 1016 is not yet touched by the keycap 1004 being pressed down by the user's fingertip 1040. Since no contact has occurred and thus no contact is detected, no signal is generated and sent to the sensor logic. Consequently, the actuation has not yet fired.

FIG. 14 shows the example assembly 900 in the next stage of the keypress of the example haptic keyboard. As compared to the previous stage, the keycap 1004 is perhaps slightly lower and the sealing platform 1012 is stretched slightly more. Between the snapshot shown in FIG. 13 and the snapshot shown here in FIG. 14, the keycap 1004 made contact (in this instance indirectly through the sealing platform) with the sensor 1016 for the sensor to send a signal to the sensor logic. The force of the contact was sufficient for the signal to indicate that the actuation mechanism should be fired.

Accordingly, FIG. 14 illustrates an active (i.e., “fired”) actuation mechanism where the upper actuation plane 906 is fully attracted to the hot lower actuation plane 910 via electrostatic forces. Actuation arrows 1402 and 1404 indicate the direction of the actuation movement. More particularly, the actuation arrows 1402, 1404 show the direction of movement of the upper actuation plane 906.

The voltmeter 1110 of FIG. 14 shows that the actuation mechanism 1020 is powered at this stage. For the purpose of further illustrating the electrically active actuation system, the lower actuation plane 910 is overlaid with a series of positive symbols (“+”) and upper actuation plane 906 is overlaid with a series of negative symbols (“−”). These overlaid symbols are only provided for illustrative purpose and are not intended to indicate a polarity or other specific electrical or magnetic states.

As depicted in FIG. 14, the spring 1024 of the return mechanism is fully compressed, the air gap 1028 is minimal to non-existent, and, similarly, the gap 1026 is significantly reduced over its defined measurement. Vents (perhaps in the upper actuation plane 906) allow for the rapid evacuation of air from the air gap 1028 during the actuation and for the rapid re-introduction of air into the air gap during the return/reset of the actuation mechanism 1020.

The snapshot star 1100 of FIG. 14 is positioned between point B (i.e., the breakover point of the snap-over) and point C of the down-keypress curve 510 of the conventional-key force-travel diagram 500.

Before actuation, the user was pushing the keycap 1004 against the upper actuation plane 906, which resisted movement because of the springs (such as spring 1024) of the return mechanism. With the actuation of the actuation mechanism 1020, the upper actuation place 906 is suddenly retracted. As a result, the user feels a sudden reduction in the force required to push the keycap down. This action simulates the sudden reduction of force exhibited by a conventional key after the breakpoint (which is point B) on the down-keypress curve 510 of the force-travel diagram 500.

FIG. 15 shows the example assembly 900 in the next stage of the keypress of the example haptic keyboard. As compared to the previous stage, the keycap 1004 is lower and the sealing platform 1012 is stretched still further. Between the previous snapshot and the snapshot shown here in FIG. 15, the actuation was released (i.e., the actuation mechanism 1020 was unpowered) and return mechanism (as represented, in part, by spring 1024) attempts to return the actuation mechanism back to its original state.

The time between firing and release of the actuation mechanism is called the actuation period. Relative to the time of downward key travel of the keycap 1004, the actuation period may be minimal to long. Typically, the actuation period ranges from 8 to 20 milliseconds.

The voltmeter 1110 of FIG. 15 shows that the actuation mechanism 1020 is unpowered at this stage. As depicted in FIG. 15, the actuation mechanism 1020 is in an inactive (i.e., “unpowered”) state where the upper actuation plane 906 is no longer attracted to the lower actuation plane 910 via electrostatic forces. Instead, the return mechanism returns the released upper actuation plane 906 back to its original position. With this example, the return is accomplished by the decompressing of the compressed springs, such as spring 1024. Return arrows 1502 and 1504 indicate the direction of the return or reset of the actuation mechanism 1020. More particularly, the return arrows 1502, 1504 show the direction of movement of the upper actuation plane 906.

As compared to the previous figure, FIG. 15 shows the spring 1024 of the return mechanism decompressing and the air gap 1028 increasing, and, similarly, the gap 1026 increasing, but still not reached its original defined size.

The snapshot star 1100 of FIG. 15 is positioned just before point C of the down-keypress curve 510 of the conventional-key force-travel diagram 500. As shown in FIG. 15, the user has not yet touched the advancing and spring-loaded upper actuation plane 906. Consequently, the user is still feeling little resistance to pressing the keycap 1004 down with his fingertip 1040. This maps nicely to just before point C on the down-keypress curve 510 of the keys of a conventional keyboard.

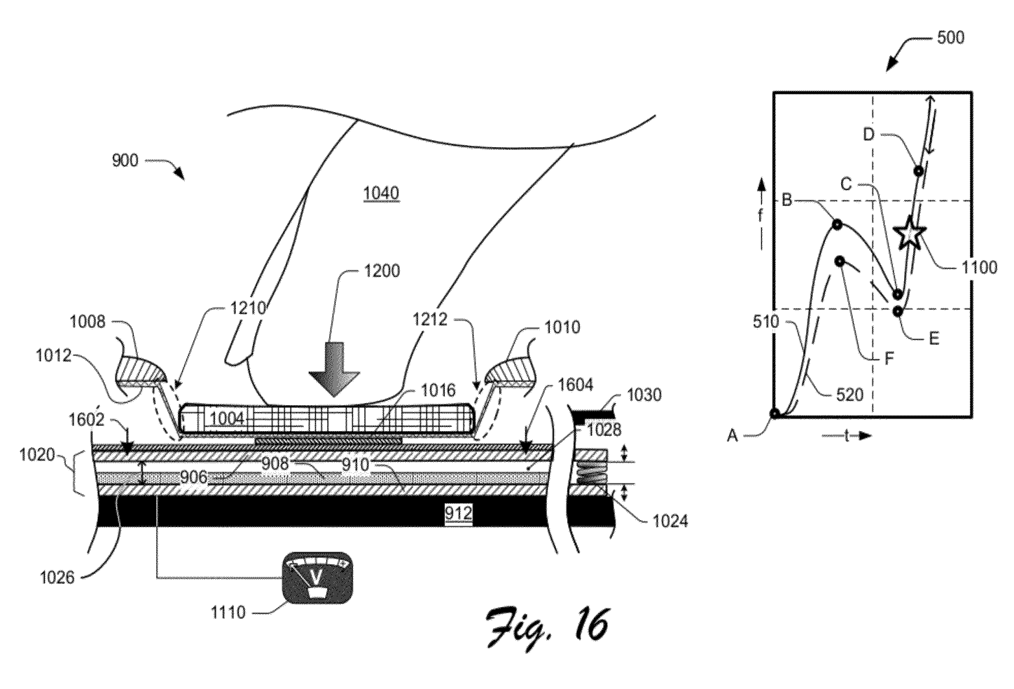

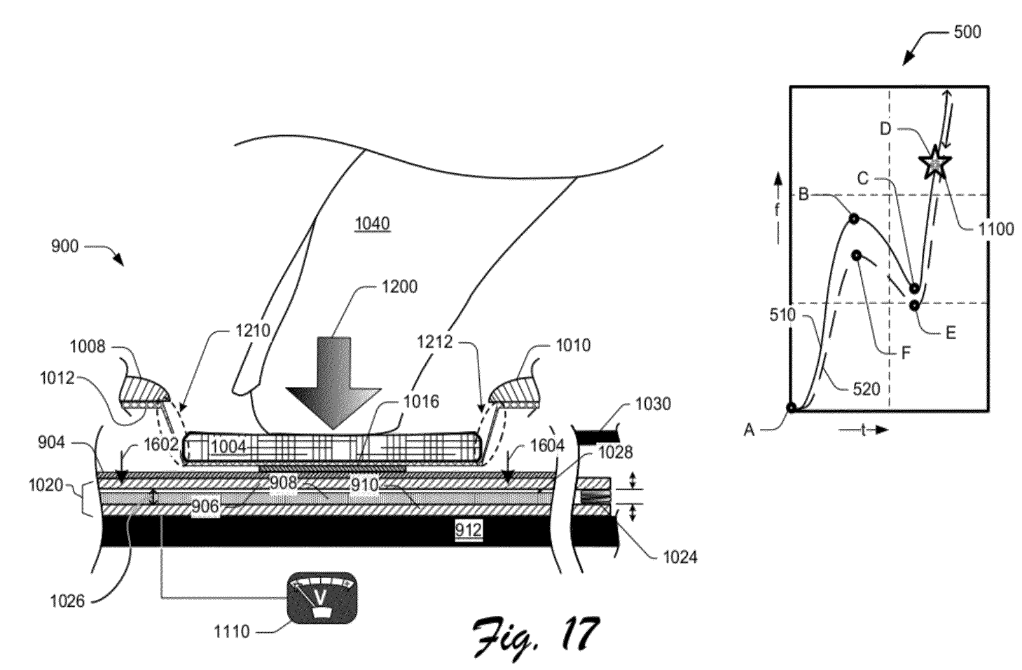

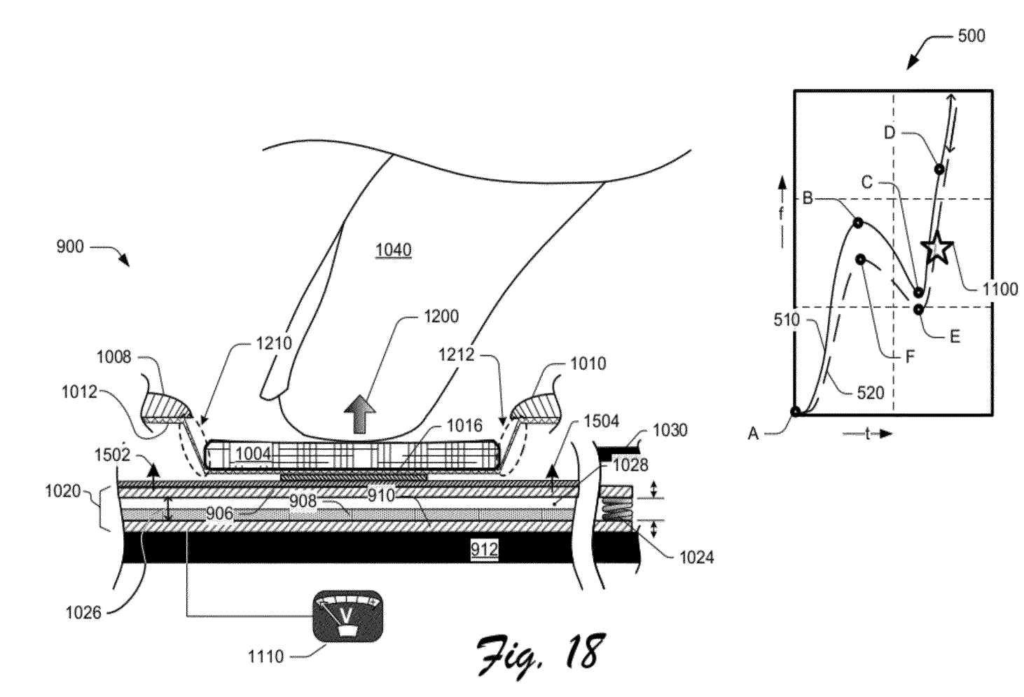

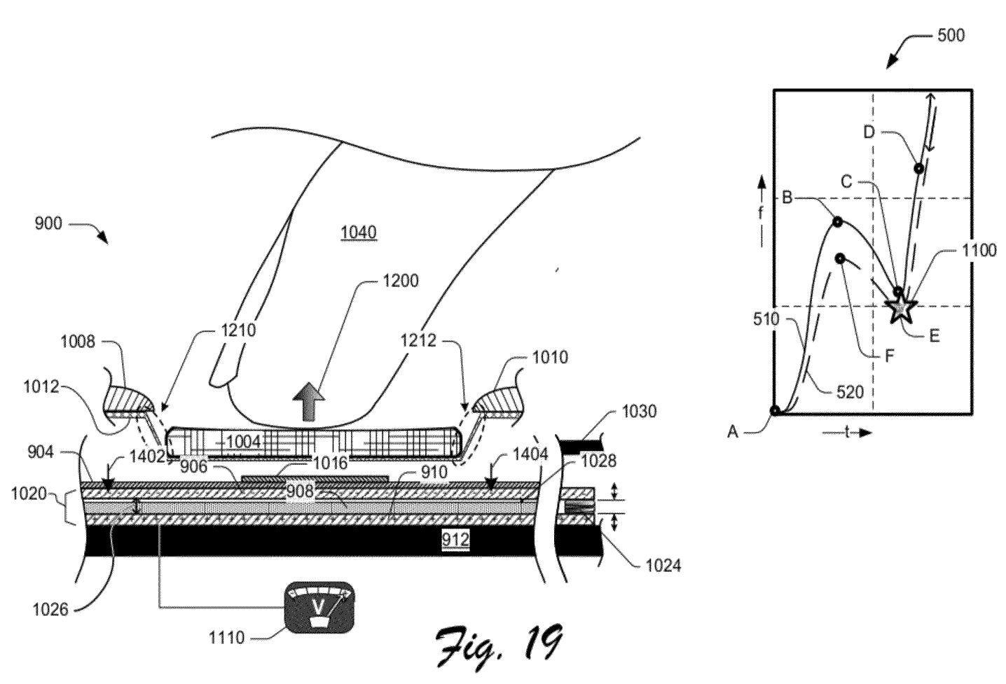

FIG. 16 shows the example assembly 900 in the next stage of the keypress of the example haptic keyboard. As compared to the previous stage, the user has pressed the keycap 1004 even lower and the sealing platform 1012 is stretched still further. Downward arrows 1602 and 1604 indicate the direction that the user's finger is moving the upper actuation plane 906 with a force and direction indicated by finger vector 1200.

Between the previous snapshot and the snapshot shown here in FIG. 16, the downward pressed keycap 1004 and the upward-moving rebounding upper actuation plane 906 have collided. After that collision, the user experiences increased resistance as he continues to press against the upper actuation plane 906, which is urged up by the return mechanism (as represented, at least in part, by the spring 1024). FIG. 16 shows a snapshot that is after that collision and after the user has been pressing the keycap down a bit.

The snapshot star 1100 of FIG. 16 is positioned between point C and point D of the down-keypress curve 510 of the conventional-key force-travel diagram 500. To the user pressing the key down, the collision with the upward-moving rebounding upper actuation plane 906 followed by the plane pushing up against the keycap feels like sudden change represented at point C on the down-keypress curve 510 of the force-travel diagram 500 of the key of a conventional keyboard.

As compared to the previous snapshot, FIG. 16 shows the spring 1024 of the return mechanism compressing and the air gap 1028 decreasing, and, similarly, the gap 1026 is decreasing. These actions are in response to the user's fingertip 1040 pressing the keycap 1004 down. The voltmeter 1110 of FIG. 16 shows that the actuation mechanism 1020 remains unpowered at this stage.

FIG. 17 shows a snapshot of the example assembly 900 in the next stage of the keypress of the example haptic keyboard. As compared to the previous stage, the user has pressed the keycap 1004 lower still and stretched the sealing platform 1012 more. Downward arrows 1602 and 1604 indicate the direction that the user's finger is moving the upper actuation plane 906 with a force and direction indicated by finger vector 1200. This finger vector 1200 of this figure is larger than it was in the previous snapshot because the user is pressing with greater force than previously. That is so because the spring-loaded upper actuation plane 906 is near or at the bottom of its downward movement. The return mechanism (as represented by spring 1024) is at or near its full compression.

The snapshot star 1100 of FIG. 17 is positioned near point D of the down-keypress curve 510 of the conventional-key force-travel diagram 500. Between the previous snapshot and this one, the user has felt greatly increasing resistance over a very short distance of travel of the keycap 1004.

To the user pressing the key down, this increased resistance feels like increased resistance graphed between points C and D on the down-keypress curve 510 of the force-travel diagram 500 of the key of a conventional keyboard.

While the user is pressing the keycap 1004 down as is shown in FIG. 17, the sensor 1016 is compressed between the keycap and the upper actuation plane 906. At one or more times during this compression, the sensor 1016 sends a signal to the sensor logic that indicates the force of that compression. The sensor logic will interpret one or more of those signals as indicating the user's intention to select that key. Consequently, the sensor logic sends an appropriate signal (e.g., key scancode) to a host computer that indicates the user selecting that key.

As compared to the previous snapshot, FIG. 17 shows the spring 1024 of the return mechanism fully or nearly fully compressed and the air gap 1028 disappearing, or nearly so, and, similarly, the gap 1026 is greatly decreasing. These actions are in response to the user's fingertip 1040 pressing the keycap 1004 down. The voltmeter 1110 of FIG. 17 shows that the actuation mechanism 1020 remains unpowered at this stage.

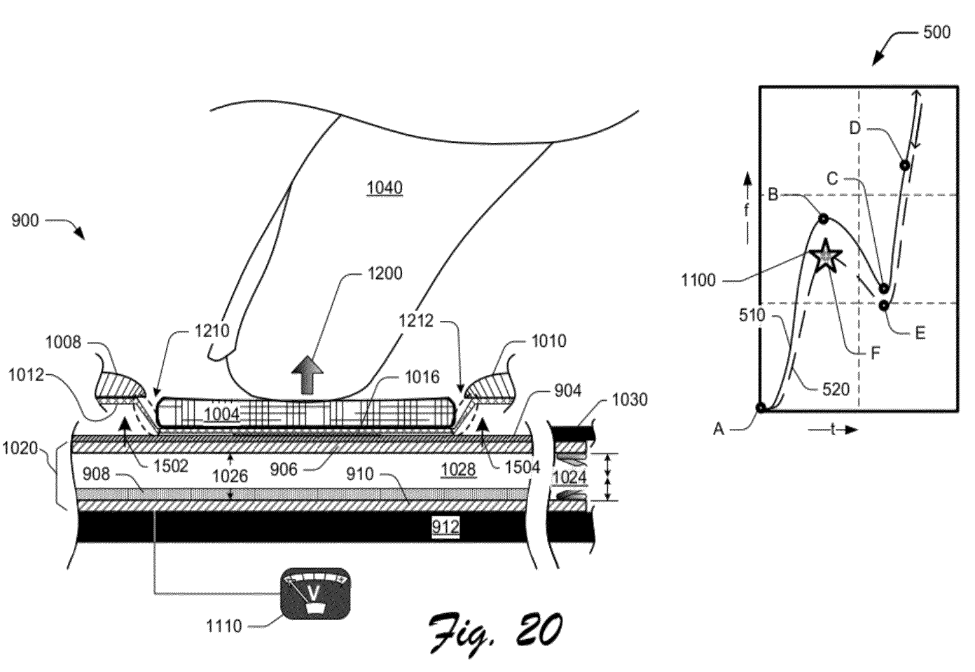

FIG. 18 shows a snapshot of the example assembly 900 in the next stage of the keypress of the example haptic keyboard. The user is now lifting his finger and that action is represented by finger vector 1200. As compared to the previous snapshot, the elastomeric sealing platform 1012 is shorter as it retracts. This action raises the keycap 1004 accordingly.

The return mechanism (as represented by springs 1024) returns the upper actuation plane 906 back to its original position. Return arrows 1502 and 1504 indicate the direction of the return of the actuation mechanism 1020. More particularly, the return arrows 1502, 1504 show the direction of movement of the upper actuation plane 906.

The snapshot star 1100 of FIG. 18 is positioned above point E of the up-keypress curve 520 of the conventional-key force-travel diagram 500. Between the previous snapshot and this one, the user has changed directions and is now lifting his finger. Under the urging of both the spring-loaded upper actuation plane 906 and the contracting elastomeric sealing platform, the keycap 1004 moves up as the user lifts his finger. To the user, this keycap movement feels like the key action before point E on the up-keypress curve 520 of the force-travel diagram 500 of the key of a conventional keyboard.

As compared to the previous snapshot, FIG. 18 shows the spring 1024 of the return mechanism expanding and the air gap 1028 increasing, and, similarly, the gap 1026 is increasing. These actions are in response to the user's fingertip 1040 lifting his finger and, thus, removing the downward force on the keycap. The voltmeter 1110 of FIG. 18 shows that the actuation mechanism 1020 remains unpowered at this stage.

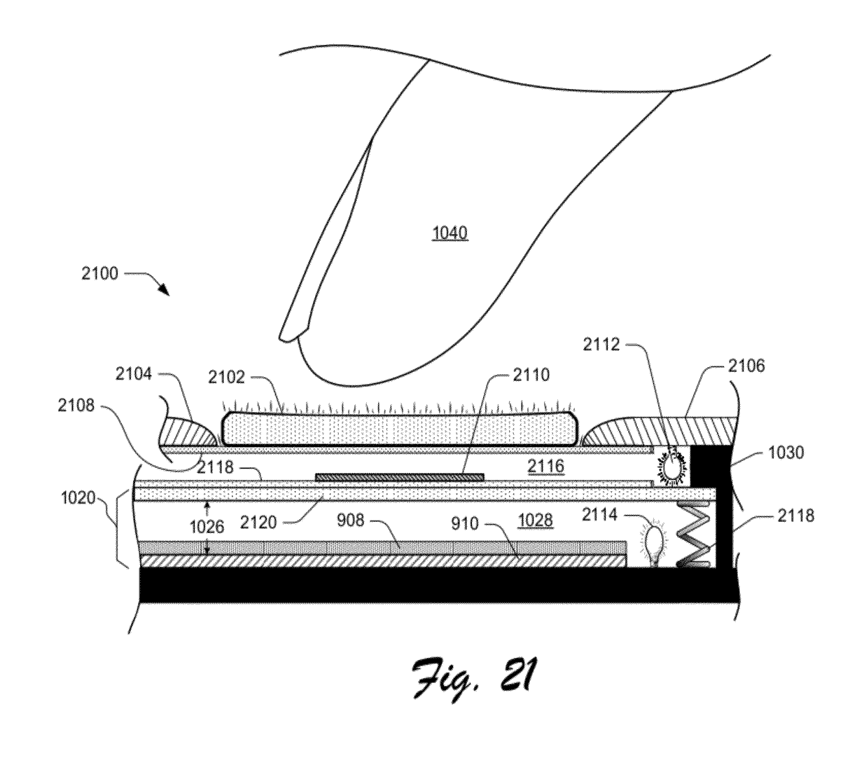

FIG. 19 shows a snapshot of the example assembly 900 in the next stage of the keypress of the example haptic keyboard. As compared to the previous stage, the keycap 1004 is perhaps slightly higher and the sealing platform 1012 has contracted slightly more. Between the previous snapshot and this snapshot shown here in FIG. 19, the actuation mechanism fired. The electrified lower actuation plane 910 violently attracts the upper actuation plane 906 via electrostatic forces. Actuation arrows 1402 and 1404 indicate the direction of the actuation. More particularly, the actuation arrows 1402, 1404 show the direction of movement of the upper actuation plane 906.

The voltmeter 1110 of FIG. 19 shows that the actuation mechanism 1020 is powered at this stage. As the planes were illustrated with FIG. 14 and for the same purposes, FIG. 19 shows the lower actuation plane 910 overlaid with a series of positive symbols (“+”) and upper actuation plane 906 is overlaid with a series of negative symbols (“−”). As depicted in FIG. 19, the spring 1024 of the return mechanism is fully compressed, the air gap 1028 is minimal to non-existent, and, similarly, the gap 1026 is significantly reduced.

The snapshot star 1100 of FIG. 19 is positioned just before point E of the up-keypress curve 520 of the conventional-key force-travel diagram 500.

FIG. 20 shows a snapshot of the example assembly 900 in the last stage of the keypress of the example haptic keyboard before returning to the neutral stage (shown in FIG. 11). As compared to the previous stage, the keycap 1004 is slightly higher and the sealing platform 1012 has contracted slightly more. Between the previous snapshot and the snapshot shown here in FIG. 20, the actuation was released (i.e., the actuation mechanism 1020 was unpowered) and the return mechanism (as represented, in part, by spring 1024) returns the actuation mechanism back to its original state.

The voltmeter 1110 of FIG. 20 shows that the actuation mechanism 1020 is unpowered at this stage. As depicted in FIG. 20, the actuation mechanism 1020 is in an inactive (i.e., “unpowered”) state where the upper actuation plane 906 is no longer attracted to the lower actuation plane 910 via electrostatic forces. Instead, the return mechanism returns the upper actuation plane 906 back to its original position. That is, the return mechanism restores the defined gap 1026 to its original state and restores the planes back to their original spaced-apart position relative to each other. Return arrows 1502 and 1504 indicate the direction of the return or reset of the actuation mechanism 1020. More particularly, the return arrows 1502, 1504 show the direction of movement of the upper actuation plane 906.

As compared to the previous snapshot, FIG. 20 shows the spring 1024 of the return mechanism, the air gap 1028, and the defined gap 1026 restored to their original states (as shown in FIG. 11).

The snapshot star 1100 of FIG. 20 is positioned just after point F of the up-keypress curve 520 of the conventional-key force-travel diagram 500. As shown in FIG. 20, the upper actuation plane 906 is or already has collided with the keycap 1004 as the user is lifting his finger. To the user, this simulates the feeling of the rubber dome reforming in the key of a conventional keyboard.

Lastly, the reset or neutral stage of the key is shown in the snapshot of FIG. 11. The keypress sequence occurs for each key on the example haptic keyboard when the user presses the key.

As can be seen by a review of FIGS. 11-20 and the above description, the actuation mechanism 1020 is fired twice during the example keypress by the user. The actuation mechanism 1020 is fired once during the down-press of the key and once during the return of the key. In other implementations, the actuation mechanism 1020 may be fired more or less frequently during a keypress and more or less frequently during each part (e.g., down-press and return) of the keypress.

### An Example Backlit Haptic Keyboard

FIG. 21 is a cross-section of a cutaway of the example assembly 2100 of an example backlit haptic keyboard. The example assembly 2100 includes a translucent and/or transparent keycap 2102. For context, a fingertip 1040 of a user is shown hovering over the keycap 2102. The keycap 2102 is with (e.g., is held within the bounds of) a keyframe 2104, 2106 of a top bezel (like top bezel 902). The keycap 2102 is with (e.g., positioned on top of) a translucent and/or transparent elastomeric sealing platform 2108. As depicted, the sealing platform 2108 is attached (e.g., adhered) to the underside of the top bezel, but in other implementations the sealing platform 2108 may be attached to other portions of the top bezel.

As shown in FIG. 2100, the sensor membrane 904 is below the keycap 2102 and the top bezel (as represented in FIG. 21 as keyframes 2104, 2106). The sensor membrane 904 connects an array of key sensors to a sensor logic 2224. Each of the key sensors (such as sensor 2110) is positioned under and corresponds to a particular keycap. Sensor 2110 is positioned directly under keycap 2102 and corresponds to that keycap. The example assembly 2100 also includes the actuation mechanism 1020, which was described above in the discussion of the example assembly 900. As shown here, the return mechanism is represented by a spring 2118.

Unlike example assembly 900 discussed above, this example assembly 2100 includes a keyboard backlighting system, which his represented in FIG. 21 by lighting elements 2112 and 2114 (i.e., backlighting elements). Both lighting elements are located inside the interior of the keyboard chassis and positioned under the keycaps (like keycap 2102).

The lighting element 2112 (and possibly others like it) is within a space 2116 formed between the sealing platform 2108 and the sensor membrane (or top of the actuation mechanism 1020). The lighting element 2114 (and possibly others like it) is under the actuation mechanism (such as actuation mechanism 1020). With light coming from the lighting element 2114 located under the actuation mechanism, a sensor membrane 2218 and an upper actuation plane 2120 may be transparent and/or translucent. In that case, the actuation plane 2120 may be, for example, glass or plastic with an electrically conductive coating or film (such as a layer of indium-tin-oxide). Alternatively, the sensor membrane 2218 and the upper actuation plane 2120 may be arranged to allow for light from the light element 2114 to pass through to space 2116 and ultimately be seen through or around the keycap 2102.

A keyboard backlighting system may include lighting from just the space 2116 (like lighting element 2112), from just under the actuation mechanism (like lighting element 2114), or from both areas. Regardless, the lighting comes from under the keycaps.

The lighting elements 2112, 2114 may be any suitable low-power lighting component, such as (but not limited to) light emitting diodes (LEDs), Electroluminescence (EL), radioactive ink, and the like.

With the keycaps (such as keycap 2102) and/or the sealing platform 2108 being translucent and/or transparent, the light from the backlighting system and flooding the space 2114 backlights the keyboard. For example, a user may see light through the keycaps. Alternatively, the user may see light coming around the keycaps and through the sealing platform of each key. Alternatively still, the user may see light coming through both the keycaps and the sealing platforms.

### Example Keyboard Components

FIG. 22 illustrates some example components in accordance with one or more embodiments, such as another example haptic keyboard 2200. The example haptic keyboard 2200 includes keyboard mechanics 2210, a sensor module 2220, an active-feedback actuation module 2230, keyboard logic 2240, a communication module 2250, and a backlighting system 2260.

The keyboard mechanics 2210 includes the mechanical components of the example haptic keyboard 2200 that are not part of the other components described as part of this example haptic keyboard. For example, such components may include (but are not limited to): a housing, keycaps, and a sealing platform.

The sensor module 2220 includes key sensors 2222 and sensor logic 2224. The sensor module 2220 also includes a sensor membrane (like the sensor membrane 904) and circuits operatively connecting the sensors 2220 to the sensor logic 2222. The above-described multiple key sensors (such as sensors 1014 and 1016) are examples of the key sensors 2222.

These key sensors serve a dual purpose. Each key sensor functions a keyswitch of a conventional key to indicate whether a user has actually pressed the key. In addition, each key sensor also signals to the appropriate components of the example haptic keyboard 600 how hard the user is pressing the keycap down. This signal is used to determine when and how to fire the haptic components in order to provide active-tactile feedback to the user during the keypress.

Conventional keyswitches were typically binary on-off type switches. The conventional keyswitches sent the appropriate signal whenever the user pressed the key down hard enough to make an electrical contact under the switch (like contacts 108, 110 shown in FIGS. 1-4).

Unlike conventional keyswitches, the key sensors (like sensor 1014, 1016) of the example haptic keyboard 600 send a series of signals or a continuous signal that indicate the force at which the user is applying to the keycap. The force indicated by the sensor signal and/or the timing of that signal determines when/whether to indicate that the user is selecting that particular key. Similarly, the indicated force and the timing of the signal sent by the sensor determine whether and/or how to fire the actuation mechanism 1020.

The sensor logic 2224 receives the key-sensing signals from the sensors 2222 and responds accordingly to send signals to the keyboard logic 2240 and/or an actuation drive logic 2234 of the active-feedback actuation module 2230.

The active-feedback actuation module 2230 includes an actuation mechanism 2232 and the actuation drive logic 2234. The actuation drive mechanism 2232 corresponds, in this example, to the actuation mechanism 1020 depicted in FIGS. 10-20. In response to the appropriate signals from the sensor logic 2224, the actuation drive logic 2234 fires the actuation mechanism 2234 with the appropriate timing and characteristics. The actuation drive logic 2234 is designed to drive the actuation planes, which have conductive properties, with an electrical signal to cause the permitted movement of at least one of the planes relative to the other of the planes effective to provide tactile feedback to the user.

A combination of the actuation drive logic 2234 and at least a portion of the sensor logic 2224 may be called a haptic logic 2270. Alternatively, the haptic logic 2270 may be a component that replaces some or all of the functionality of the actuation drive logic 2234 and the sensor logic 2224.

The keyboard logic 2240 interprets the signals sent from the sensor logic 2224 to determine which key code (i.e., scan code) to send to the host computer. The key code identifies which key the user pressed to the host computer.

The communications module 2250 is operatively connected to the host computer. That may be a wired or wireless connection. The communications module 2250 receives the key code from the keyboard logic 2240 and sends that code on to the host computer.

The backlighting system 2260 includes one or more lighting elements that are positioned so a user, through transparent and/or translucent keycaps (or flexible platform), can see their light. In some implementations, the backlighting system 2260 may be designed to light specific keys or specific groups of keys.

Any suitable hardware, software, and/or firmware can be used to implement the sensor logic 2224, the actuation drive logic 2234, the keyboard logic 2240, the haptics logic 2270, and the communication module 2250.

### Example Processes

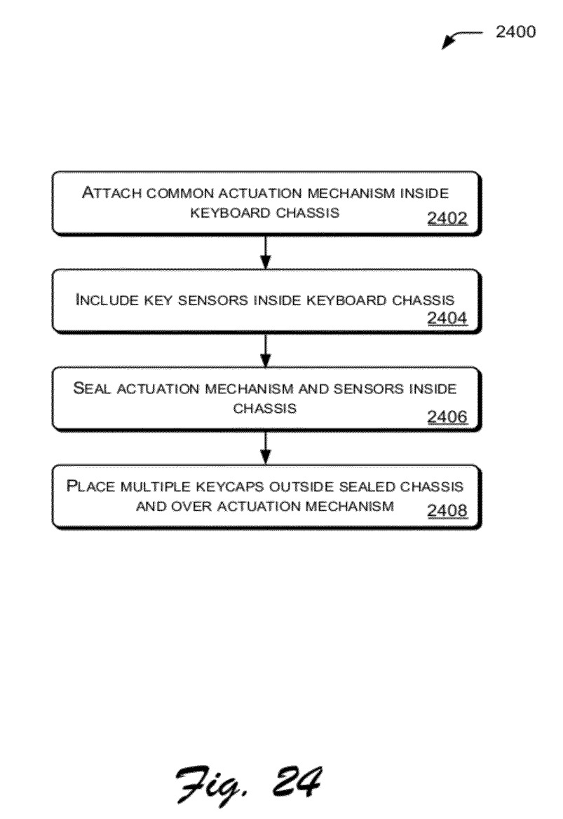

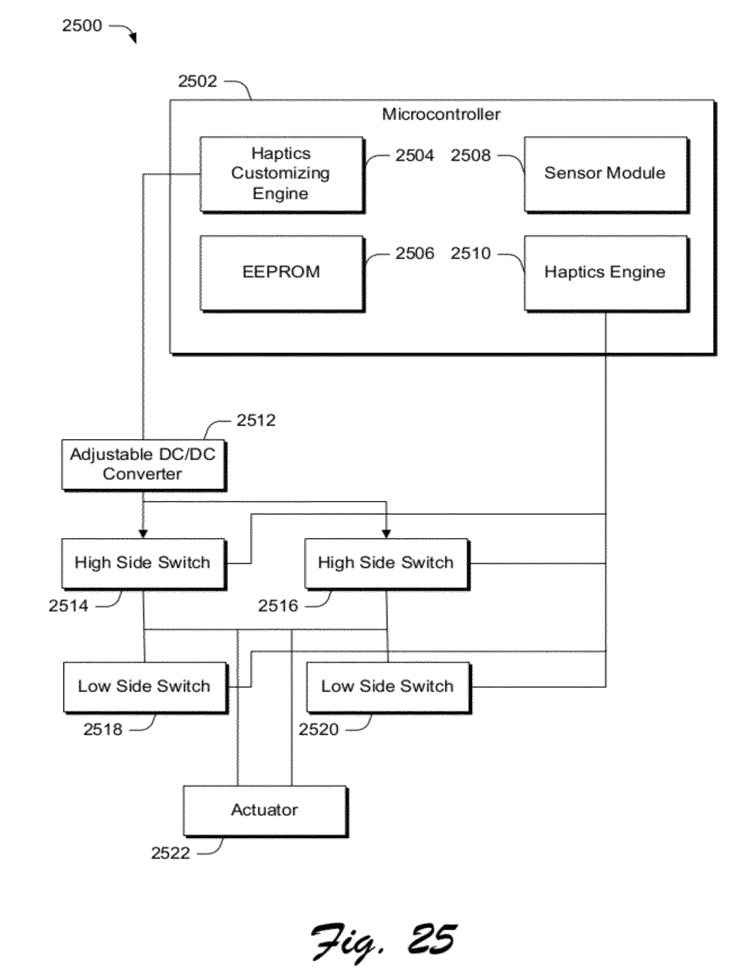

FIGS. 23 and 24 are flow diagrams illustrating example processes 2300 and 2400 that implement the techniques described herein for the Haptic Keyboard Featuring a Satisfying Tactile Keypress Experience.

FIG. 23 illustrates the example process 2300 for providing a satisfying tactile keypress experience (i.e., snap-over simulation) with a haptic keyboard. The process 2300 is performed, at least in part, by a keyboard, which includes, for example, the example haptic keyboard 600 or 2200 of FIGS. 6-22.

As shown here, the process 2300 begins with operation 2302, where a haptic profile is set for the haptic keyboard. This profile sets various parameters that define how and when the actuation mechanism is fired. The parameters in the haptic profiles can include (by way of example and not limitation): value of a single voltage pulse; a series of values of voltage pulses having various frequencies and amplitudes; keypress force (and sequence) that triggers a key selection; keypress force (and sequence) that triggers an actuation firing; rate of change of force, time key was pressed or not pressed, frequency of pressing and/or releasing and/or holding or not holding one or more keys.

Next, at operation 2304, the keyboard monitors receive input from the key sensors (such as sensors 1014, 1016 of the example haptic keyboard 600). The input is the keypress force at which the user presses the key. The sensor logic sends the sensor signals to both the haptic logic and the keyboard logic. The ranges of keypress force (applied by the user's finger) is typically between 10-150 grams of force.

At operation 2306, the haptic logic determines whether to fire the actuation mechanism. If not, then the process returns back to the sensor-monitoring operation 2304. If so, then the process moves onto the operation 2308.

In some implementations, the actuation mechanism may be fired at a force of 20 to 120 grams during the downward keypress. In other implementations, the actuation mechanism may be fired at a force of 40 to 80 grams during the downward keypress. In some implementations, the actuation mechanism may be fired at a force of 5 to 50 grams during the upward keypress. In other implementations, the actuation mechanism may be fired at a force of 10 to 30 grams during the downward keypress.

A determination to fire that actuation mechanism is based upon the circumstances and conditions of the keypress. The circumstances and conditions may be part of the haptic profile. For example, a determination to fire the actuation mechanism may be made during the downward motion of the keypress and at one or more specified forces. Also, for example, a determination to fire the actuation mechanism may be made during the upward motion of the keypress and at one or more specified forces.

During a full keypress (both down and up), the actuation mechanism may be fired multiple times. As is illustrated in FIGS. 11-20 and discussed above, the actuation mechanism may be fired once during the downward keypress and once during the upward keypress. In response to detecting that the user is holding a key down for a defined period of time (without lifting his finger), the haptic profile may indicate that a decision be made to repeatedly and/or periodically fire the actuation mechanism until, of course, the user lifts his finger.

At operation 2308, the actuation mechanism is fired in response to a determination at operation 2306 to do so. When firing the actuation mechanism, many different factors may be applied. Examples of such factors include (but are not limited to): amount of voltage, rate of application of that voltage, how long the actuation is held, when the actuation is released, the rate of the release of the actuation voltage, etc. Depending upon various factors (including the set haptic profile and the current keypress conditions), different combination of the factors may be utilized in a given actuation. After an actuation firing, the process returns back to the sensor-monitoring operation 2304.

At operation 2310, the keyboard logic determines whether the user intended to select a key and which key is selected. If the sensor signal does not indicate a key selection, then the process returns back to the sensor-monitoring operation 2304. If a key is determined to be selected, then the process moves onto the operation 2312. In some implementations, the key is selected when there is a force of 20 to 130 grams during the downward keypress. In other implementations, the key is selected when there is a force of 40 to 80 grams during the downward keypress.

At operation 2312, the keyboard logic sends a signal via the communications module to the host device that identifies the key that the user selected. After that, the process returns back to the sensor-monitoring operation 2304.

The process 2300 continues as long as the keyboard is active and in use. The haptic profile may be set at anytime (at operation 2302) without halting process 2300. When reset or adjusted, the other operations of the process 2300 are affected by the new haptic profile.

With at least implementation, the process 2300 directs the firing of the actuation mechanism 1020 in the manner described above and shown in FIGS. 11-20.

FIG. 24 illustrates the example process 2400 for assembling a haptic keyboard that provides satisfying tactile keypress experience (i.e., snap-over simulation). The process 2300 is performed, at least in part, by assembling machinery and/or tools for constructing and/or manufacturing keyboards. The process 2300 assembles as least some of the components and parts of a keyboard like, for instance, the example assembly 900 of the haptic keyboard 600 of FIGS. 9-20.

As shown here, the process 2400 begins with operation 2402, where a common active-feedback actuation mechanism (e.g., actuation mechanism 1020) is attached to a keyboard chassis. As shown in FIG. 10, the actuation mechanism 1020 is attached to the base 912 of chassis 602. Of course, this chassis may include the housing of a device, which is more than just a keyboard.

Next, at operation 2404, the key sensors are placed inside the keyboard chassis as well. For example, as shown in FIGS. 9-20, the key sensors 1014 and 1016 are connected to the keyboard membrane 904 and placed over the actuation mechanism 1020. The membrane is placed and attached in such a manner so that each key sensor falls directly under the keycaps (such as keycaps 1002, 1004).

At operation 2406, the chassis is sealed shut with the key sensors and actuation mechanism inside. For example, as shown in FIGS. 9-20, the top bezel 902 and the elastomeric sealing platform 1012 effectively seal the key sensors and actuation mechanism inside the chassis. As used here, the sealed chassis is closed tight and impervious to the ingress of contaminants and debris includes water.

At operation 2408, multiple keycaps are placed outside the sealed chassis and over the common active-feedback actuator. For example, as shown in FIGS. 9-20, the keycaps 1002, 1004 are placed over the sealed platform 1012 and inside keyframes, which are built into the top bezel to receive the keycaps. The keycaps 1002, 1004 are located over the common actuator, which is sealed inside the keyboard chassis.

In addition or alternatively, the various electronic components (such as haptic logic, keyboard logic, and communications module) are also sealed inside the chassis.

### Additional and Alternative Implementation Notes

The operations of the method illustrated in FIG. 24 can be implemented in connection with any suitable hardware, software, firmware, or combination thereof. For example, consider FIG. 25, which illustrates a high-level block diagram of a system that can be incorporated into a device and utilized to implement the functionality described herein. In the illustrated and described example, system 2500 includes a microcontroller 2502, which, in turn, includes a haptics customizing engine 2504, a computer-readable storage media in the form of an EEPROM 2506, a sensor module 2508, and a haptics engine 2510. In addition, system 2500 includes an adjustable DC/DC converter 2512, high side switches 2514, 2516, low side switches 2518, 2520, and an actuator 2522. The various components of system 2500 can be configured in any suitable manner in order to provide haptic feedback as described herein.

Unless the context indicates otherwise, the term “housing” as used herein also includes a chassis or other framework designed to hold or retain the components of the haptic keyboard described herein and possibly other computing components (e.g., a CPU, memory, graphics processor, hard drive, I/O subsystems, network communications subsystems, etc.).

Herein, each of the keycaps (such as 1002, 1004) is shown alone within the bounds of its own keyframe opening. In alternative implementations, multiple keycaps may be positioned within a common keyframe opening. In that case, multiple keycaps are with (e.g., over, on, attached, adhered, etc.) a flexible platform (such as platform 1012) that closes the common keyframe opening.

Herein, the user is described has touching or pressing the keys of the example haptic keyboard. Indeed, many of the drawings (such as FIGS. 12-20) show the user touching the key with his finger 1040. While users typically touch keys with their fingers, it should be understood by those of ordinary skill in the art that user is not limited to touching the keys with his finger. Alternatively, the user may use another body part or use a tool (e.g., a pencil) to press the keys.

Any suitable type of technology can be utilized to implement the key sensors (such as sensors 1014, 1016, and 2222) such that each sensor is capable of sensing when and how hard a user has pressed its corresponding key. Examples of suitable, known technologies include (by way of example and not limitation): membrane switch. capacitive switch, Force Sensing Resistor (FSR). multistage switch, Micro-Electro-Mechanical Systems (MEMS), inductive sensor, Hall-effect, and the like.

Alternatively, a combination of sensors may be employed. One key sensor per keycap may be used to indicate when the user is pressing a key or not. This may appear and be arranged much like the key sensors (such as sensors 1014, 1016) as shown herein. Such a key sensor may be a conventional keyswitch. That key sensor may be combined with a generalized common force-sensing sensor that determines the force applied to the actuation mechanism by any key rather than by a particular key. An example such a force-sensing mechanism is disclosed in U.S. Provisional Patent Application Ser. No. 61/347,768, which is incorporated herein by reference.

As depicted, the sealing platform 1012 may be an expanse of material covering several keyframes and be attached (e.g., adhered) to the underside of the top bezel 902. In alternative implementations, the sealing platform 1012 may cover only one keyframe and/or be attached to other portions of the top bezel 902 or the housing 602. In general, the sealing platform may be attached to the keycaps and the keyframes in a manner that seals the space in between and also allows the keycaps to move in a downward direction. The elastomeric sealing platform 1012 may be constructed from any suitable elastomeric material, which includes (but is not limited to): silicone, butyl rubber, thermoplastic elastomer, latex rubber, foam (e.g., neoprene, polyethylene), flexible adhesive, natural or synthetic fabrics, and the like. In some instances, a non-elastomeric material, like polycarbonate, may be used for the sealing platform.

The elastomeric sealing platform (such as 1012 and 2108) performs a dual purpose. It seals the keyboard housing, thereby keeping the internal keyboard parts free from debris and water. The sealing platform also stretches and resists the user's keypress of the keycaps (such as keycap 1004). In alternative implementations, this dual functionality may be provided by separate components. One component seals and the other component resists the keypress (e.g., a spring).

The actuation mechanism (such as actuation mechanism 1020) is described herein as producing a movement to effect a tactile feedback to a user by using electrostatic forces to attract a pair of conductive planes. In alternative embodiments, the movement may be cause by other types of electro-mechanical actuators, which include (but are not limited to) those based upon: electroactive polymers (EAP), piezoelectric, solenoids, and the like.

The actuation mechanism (such as actuation mechanism 1020) is described herein as having a pair of actuation planes (906 and 910). Alternative assemblies of the haptic keyboard may include more than just the pair of planes. Those alternative assemblies may include a defined gap between each pair of stacked-up and spaced-apart planes. This effectively creates a layered stack of multiple actuation mechanisms.

Depending upon the particular implementation, the actuation planes (906 and 910) may also be described as a layer, plate, stratum, substrate, laminate, sheet, film, coating, page, blanket, expanse, foil, leaf, membrane, pane, panel, ply, slab, veneer, or the like.

As depicted herein, each of the actuation planes (906 and 910) is shown as a single stratum of material. However, other embodiments may use multiple strata of material. For example, some embodiments may use two, three, four, or more layers of material. Regardless of the number of layers used for each plane, one or more layers have conductive properties.

For example, in at least some embodiments, each of the actuation planes (906 and 910) are formed from or include an electrically conductive material. Examples of conductive material that the planes may include or be formed from include (but are not limited to): silver, iron, aluminum, gold, brass, rhodium, iridium, steel, platinum, tin, indium tin oxide, titanium, copper, or some other sheet metal. Other materials can, of course, be utilized without departing from the spirit and scope of the claimed subject matter.

As depicted herein, the actuation mechanism (such as 1020) moves at least one of the pair of the actuation planes (906 and 910) down and the return mechanism moves the planes up when actuation is deactivated. This movement can be described as being substantially normal to and/or from the keycap (such as keycap 1004). Alternatively, this movement can be described as being parallel with the movement of the key travel of the key cap.

Dielectric material (such as dielectric layer 908) can include any suitable type of dielectric material such as (by way of example and not limitation): air, glass, ceramic, mica, piezo materials, FR4, plastic, paper, elastomeric material, gel and/or other fluidic or non-fluidic material. Although it is not technically a material, a vacuum may operate as an effective dielectric for some implementations. Alternately or additionally, in at least some embodiments, the return mechanism (as represented by springs 1022, 1024) can be formed from any suitable material, such as thermoplastic elastomer, metal, and the like.

In one or more embodiments, various parameters associated with the assembly of the haptic keyboard can be selected in order to provide desired operating characteristics. For instance, with the example assembly 900, parameters associated with the dimension of air gap 1028, the thickness of the dielectric material 908, and the dielectric constant of dielectric material 908 can be selected in order to provide desired operating characteristics. In at least some embodiments, the following parameter values can be used:

| Parameter | Value |
|---|---|
| Air Gap dimension | 1 micron to 1 cm |
| Dielectric Thickness | 0.05 to 2.0 mm |
| Relative dielectric constant | Greater than or equal to 1 |

It is to be appreciated and understood that other types of return mechanisms can be utilized without departing from the spirit and scope of claimed subject matter. For example, alternative return mechanisms might return the upper plane of the actuation mechanism back to its original position without biasing or spring forces. This return action may be accomplished via repulsion, attraction, or other magnetic or electromagnetic forces. Also, other mechanical actions may restore the gap between the substrates.

In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplaned that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

These processes are illustrated as a collection of blocks in a logical flow graph, which represents a sequence of operations that can be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks can be combined in any order to implement the processes or an alternate process. Additionally, individual blocks may be deleted from the processes without departing from the spirit and scope of the subject matter described herein.

The term “computer-readable media” includes computer-storage media. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

Unless the context indicates otherwise, the term “logic” used herein includes hardware, software, firmware, circuitry, logic circuitry, integrated circuitry, other electronic components and/or a combination thereof that is suitable to perform the functions described for that logic.

What is claimed is:

1. A haptic keyboard featuring a satisfying tactile keypress experience for a user, the keyboard comprising:
a housing having at least one keyframe that defines an opening in a top of the housing, the keyframe opening being closed by at least one flexible platform;
a plurality of keycaps, each keycap being positioned with the keyframe opening and over the at least one flexible platform;
a plurality of key sensors, inside the housing, operably associated with the plurality of keycaps and each key sensor being positioned under a corresponding one of the plurality of keycaps;
a common active-feedback actuation mechanism, inside the housing, operably associated with the plurality of keycaps and positioned under the plurality of keycaps, the actuation mechanism configured to provide tactile feedback to the user when the user presses one of the plurality of keycaps via that keycap.

2. A haptic keyboard as recited in claim 1, wherein the actuation mechanism includes a pair of actuation planes held in a spaced-apart position relative to each other and with a defined gap therebetween, the actuation mechanism being configured to permit at least one of the planes to move relative to the other effective to provide tactile feedback to the user when the user presses one of the plurality of keycaps via that keycap.

3. A haptic keyboard as recited in claim 2, wherein the actuation mechanism includes a return mechanism that is operably associated with at least one of the pair of actuation planes, the return mechanism being configured to return the pair of planes, after a movement of the planes relative to each other, back to the spaced-apart position relative to each other and restore the defined gap therebetween.

4. A haptic keyboard as recited in claim 2, further comprising an actuation drive logic that is operably connected to the actuation mechanism and configured to drive the actuation planes, which have conductive properties, with an electrical signal to cause a permitted movement of at least one of the planes relative to the other of the planes effective to provide tactile feedback to the user.

5. A haptic keyboard system as recited in claim 2, wherein the permitted movement of at least one of the planes relative to the other of the planes simulates, at least in part, a feel of a snap-over keypress of a conventional key to a user pressing at least one of the plurality of keycaps.

6. A haptic keyboard system as recited in claim 2, wherein the permitted movement of at least one of the planes relative to the other of the planes simulates, at least in part, a feel of a keypress having non-linear force-travel characteristics to a user pressing at least one of the plurality of keycaps.

7. A haptic keyboard as recited in claim 1, wherein each of the key sensors is configured to send signals in response to a user pressing a corresponding keycap of the plurality of keycaps.

8. A haptic keyboard system as recited in claim 1, wherein each of the key sensors is configured to send signals in response to a user pressing a corresponding keycap of the plurality of keycaps, the haptic keyboard further comprising an actuation drive logic that is operably connected to the actuation mechanism, the actuation drive logic being configured to respond to force-sensing signals from one or more of the key sensors by driving the common active-feedback actuation mechanism.

9. A haptic keyboard as recited in claim 1, wherein each of the key sensors is configured to send force-sensing signals in response to a force applied by the user pressing a corresponding keycap of the plurality of keycaps.

10. A haptic keyboard as recited in claim 1, further comprising a common force-sensing sensor configured to sense a force applied to the common active-feedback actuation mechanism by any of the plurality of keycaps.

11. A haptic keyboard as recited in claim 1, wherein the housing is sealed to protect the interior of the housing from ingress of contaminants.

12. An assembly comprising:
a chassis having at least one keyframe, that keyframe defining an opening in a top of the chassis;
a keycap that is positioned with the opening;
a key sensor, inside the chassis, that corresponds to the keycap;
an active-feedback actuation mechanism, inside the chassis, operably associated with the keycap, the actuation mechanism including a pair of actuation planes that have conductive properties and are held in a spaced-apart position relative to each other and with a defined gap therebetween, the actuation mechanism being configured to permit at least one of the planes to move relative to the other effective to provide tactile feedback to the user when the user presses the keycap.

13. An assembly as recited in claim 12, further comprising an actuation drive logic that is operably connected to the actuation mechanism and configured to drive the actuation planes with an electrical signal to cause a permitted movement of at least one of the planes relative to the other of the planes effective to provide tactile feedback to a user pressing the keycap.

14. An assembly as recited in claim 12, wherein the keyframe opening is sealed by a flexible platform and both the key sensor and the active-feedback actuation mechanism are sealed within the chassis.

15. An assembly as recited in claim 12, wherein:
a plurality of keycaps which includes the keycap, wherein each keycap of the plurality is positioned with the opening;
the active-feedback actuation mechanism is positioned under the plurality of keycaps.

16. An assembly as recited in claim 12, further comprising one or more backlighting elements inside the chassis and positioned below the keycap, the keycap being transparent and/or translucent and the backlighting elements being configured to emit light through the keycap.

17. An assembly as recited in claim 12, further comprising one or more backlighting elements inside the chassis and positioned below the active-feedback actuation mechanism, the keycap and the active-feedback actuation mechanism being transparent and/or translucent and the backlighting elements being configured to emit light through the keycap and the active-feedback actuation mechanism.

18. A computing device comprising a device housing that includes a haptic keyboard as recited in claim 12.

19. A method of simulating a feel of a snap-over keypress to a user, the method comprising:
monitoring input from one or more sensors, wherein at least one of the sensors includes a key sensor that is associated with a keycap of a haptic keyboard;
in response to the input from one or more of sensors, determining whether to trigger an active-feedback actuation mechanism associated with the keycap;
in response to the determining whether to trigger, firing the active-feedback actuation mechanism to provide tactile feedback to the user pressing the keycap, wherein the firing includes:
sending an electrical signal to the active-feedback actuation mechanism to drive at least one of a pair of spaced-apart electrically conductive planes to be attracted to the other of the pair of planes via electrostatic forces therebetween;
releasing the attracted pair of electrically conductive planes and allowing the planes to return to their original spaced-apart arrangement.

20. A method as recited in claim 19, wherein the firing of the active-feedback actuation mechanism includes holding the attracted planes together for a defined amount of time between the sending and releasing.

21. A method as recited in claim 19, further comprising:
in response to the input from the key sensor, determining whether a user intended to select the keycap;
in response to the determining whether a user selected a key, communicating that selected key was selected by the user.

22. A method as recited in claim 19, wherein the input of the monitoring includes an indication of a force with which a user is pressing the keycap.

23. A method as recited in claim 19, further comprising repeating the firing of the active-feedback actuation mechanism associated with the keycap multiple times during a full keypress of the keycap to provide tactile feedback to the user pressing the keycap.

24. A method as recited in claim 19, further comprising repeating the firing of the active-feedback actuation mechanism associated with the keycap multiple times in response to a determination that the user is holding the keycap down.
